(19) United States
(12) Patent Application Publication
(10) Pub. No.: US 2019/0099767 A1
(43) Pub. Date: Apr. 4, 2019

(54) SHOWER APPARATUS AND WATER FLOW CONTROL ASSEMBLY

(71) Applicant: FOCUSED REALITY, INC., Cranston, RI (US)

(72) Inventors: Christopher Michael CAPP, Cranston, RI (US); Patrick BAILEY, Charlotte, NC (US); Jeremy LOSAW, Charlotte, NC (US); Raeshon MCNEIL, Charlotte, NC (US); John LAVERACK, Southbury, CT (US); Kurt Raymond WESEMAN, West Haven, CT (US); Cobern Eugene MCGRAW, Stratford, CT (US)

(21) Appl. No.: 16/148,857

(22) Filed: Oct. 1, 2018

Related U.S. Application Data
(60) Provisional application No. 62/567,226, filed on Oct. 2, 2017.
(60) Provisional application No. 62/570,658, filed on Oct. 10, 2017.

(51) Int. Cl. B05B 1/16; B05B 1/18; E03C 1/04; E03C 1/06

(52) U.S. Cl. CPC B05B 1/1681; E03C 1/06; E03C 1/0409; B05B 1/185

(57) ABSTRACT

A shower apparatus includes: a mounting bracket or mounting component; and a rigid component or shower panel. The shower panel includes one or more spray arrangements of sprayers, spray arrays, or spray patterns, and fluid passageways connecting water input to the one or more spray arrangements. The shower apparatus further includes a water flow control assembly for selecting a single flow from a plurality of flows to different combinations of the spray arrangements. The water flow control assembly comprises a plurality of buttons, a constrained strip, and a plurality of valves. A button when selected deflects the constrained strip—which is constrained and capable of deflection at a single location—into a corresponding valve to activate flow through the valve. This deflection straightens a previous deflection, thereby closing the previously open valve.

### COPYRIGHT STATEMENT

All of the material in this patent document, including the computer program listing, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### COMPUTER PROGRAM LISTING

Submitted concurrently herewith via the USPTO's electronic filing system, and incorporated herein by reference, are computer program files including instructions, routines, and/or other contents of several computer programs. A table setting forth the name and size of files included in the computer program listing is included below.

| File Name | Creation Date | File Size (bytes) |
|---|---|---|
| ascify.txt | 09/19/2017 12:04 | 37473 |
| readme.txt | 10/02/2017 14:25 | 2796 |
| archive1.txt | 10/02/2017 14:13 | 22478505 |
| archive2.txt | 10/02/2017 14:13 | 22478162 |
| archive3.txt | 10/02/2017 14:14 | 22477819 |
| archive4.txt | 10/02/2017 14:14 | 21918408 |

One of these files, “readme.txt”, contains instructions for extracting information from the “archive” text files. These “archive” text files represent a compressed binary file that has been converted to ascii format. These files can be converted back to a compressed .zip archive utilizing an assembly conversion program source code for which is contained in “ascify.txt”. The readme file includes instructions for compiling and running this conversion program, and instructions for converting the “archive” text files to a compressed, binary file.

This compressed, binary file includes two .mp4 videos illustrating an exemplary water control assembly embodying aspects and features of one or more preferred embodiments of the invention, and further includes an eDrawings file for an exemplary water control assembly embodying aspects and features of one or more preferred embodiments of the invention. The eDrawings file can be opened using eDrawings software available from Dassault Systemes SolidWorks Corporation, a Delaware corporation having a principal place of business at 175 Wyman Street, Waltham, Mass. 02451.

### BACKGROUND OF THE INVENTION

The present invention generally relates to shower apparatus and, in particular, shower apparatus having multiple sprayers and a water control assembly for selectively controlling water flow.

Not everyone uses a shower just for cleaning, and many use showers for relaxing. Common showers are singular in approach to delivering water to the body, which approach exposes the rear of the head, neck and back when a user faces away a shower. When a user turns to cover these areas with water from the shower, the user exposes his or her arms, chest and stomach. This creates “cold zones” on the body, and the user has no option to achieve complete coverage.

Use of shower apparatus having multiple sprayers is believed to result in significant improvement in water coverage of the body, thereby enhancing the relaxation experienced when taking a shower. Shower apparatus having multiple sprayers are disclosed, for example, in the following U.S. patent properties: 2006/0236451; U.S. Pat. Nos. 7,987,533; 7,448,096; 6,829,790; 6,745,414; 6,550,6080; 6,415,461; 6,079,060; 5,909,969; 5,799,346; 5,692,252; 5,564,139; 5,148,556; 5,060,322; 4,927,083; 4,872,225; 4,809,369; 4,554,690; 3,984,879; 3,971,074; 3,913,839; 944,611; 924,602; 819,582; 475,754; 439,793; and 432,712. United States patent publication 2016/0059243 discloses yet additional shower apparatus. Still addition show apparatus including improvements in ease of installation and ability to accommodate users of different heights are disclosed in U.S. Pat. No. 9,578,994, the disclosure of which is incorporated herein by reference. It is believed that one or more still additional improvements in shower apparatus—including water control assemblies thereof—are achieved by at least one preferred embodiment of the present invention.

### SUMMARY OF THE INVENTION

The present invention generally relates to apparatus and methods pertaining to adjustable height suspended shower apparatus with multiple sprayers. Moreover, the present invention includes many aspects and features.

In an aspect, a shower apparatus comprises a mounting bracket or mounting component; and a rigid component or shower panel; wherein the shower panel comprises one or more spray arrangements of sprayers, spray arrays, or spray patterns, and fluid passageways connecting water input to the one or more spray arrangements.

In a feature, each sprayer comprises a nozzle.

In a feature, each sprayer comprises a nozzle a small opening for creating a mini jet stream of pressurized water.

In a feature, each fluid passageway comprises piping, tubes, or other fluid conduits.

In a feature, the mounting component is configured for mounting or is mounted to a wall of a shower area or bathtub.

In a feature, the shower panel is attached to the mounting component and is configured to transition to different positions at different heights.

In a feature, the shower panel is attached to the mounting component and is configured to transition by sliding to different positions at different heights. The shower panel preferably is lockable in each position, whereby the one or more spray arrangements located on the shower panel—which is rigid—are all commonly adjustable for accommodating persons of different heights for taking showers.

In a feature, the one or more spray arrangements of the shower apparatus comprise an uppermost spray arrangement, located on a top portion of the shower panel; a second spray arrangement located on a curved distal end portion of the shower panel at an elevation below the uppermost spray arrangement; and one or more lowermost spray arrangements. The one or more lowermost spray arrangements preferably comprise third and fourth spray arrangements located on a lower portion of the shower panel on opposites lateral sides of a water flow control assembly, with a rigid neck portion of the shower panel extending upwardly between and interconnecting the lower portion and the top portion of the shower panel. The lowermost spray arrangements may be symmetrically arranged on opposite sides of the water flow control assembly relative to a vertical axis of the neck portion.

In a feature, the shower panel is connected to and slides relative to the mounting component through slots that vertically extend along a surface of the mounting component between proximate a bottom of the mounting component to proximate a top of the mounting component.

In a feature, the mounting component comprises dual friction support tracks.

In a feature, the mounting component comprises a water pipe exit slot that constitutes a water input to a water flow control assembly.

In a feature, the shower panel is configured to transition to each of an uppermost position; an upper position; a lower position; and a lowermost position. When the shower panel is locked at an upper position, exterior top surfaces of the mounting component and the shower panel preferably align at to form a continuous curvature of an upper portion of the shower apparatus when in such position. Also, when the shower panel is in the lower position, an exterior bottom surface of the mounting component and an exterior bottom surface of the shower panel preferably align to form a continuous curvature of a bottom of the shower apparatus when in such position. When the shower panel is in the lowermost position, an exterior bottom surfaces of the mounting component and the shower panel preferably do not align to form a continuous curvature of a bottom of the shower apparatus when in such position. Instead, the exterior bottom surface of the shower panel preferably is located at an elevation below an elevation of the exterior bottom surface of the mounting component.

In a feature, the shower apparatus further comprises a water flow control assembly that includes four buttons vertically aligned in a single column array. Each button preferably is a pushbutton, and the four preferably comprise, from top to bottom: a “FULL” button, by which water flows to all of the spray arrangements; a “BODY” button, by which water flows to only the spray arrangements; a “HEAD” button, by which water flows only to the uppermost spray arrangement; and a “RINSE” button, by which water flows only to the sprayers of the arrangements.

In a feature, the shower panel comprises one or more gripping areas that are configured to facilitate frictional gripping by a person of the shower panel when manually sliding the shower panel for height adjustment. A gripping area may be formed by applying a pattern of silicone to and slightly extending above the surface of the shower panel, such as through molding of silicone onto the shower panel; and a gripping area may be formed by applying an adhesive decal or patch having an exposed surface area facilitating frictional gripping. Preferably, a gripping area extends between opposite sides of the shower panel above the water flow control assembly; the shower apparatus includes a gripping area extending between opposite sides of the shower panel around an upper area of the push buttons of the water flow control assembly; the shower apparatus includes a gripping area located on the sidewall on the right side of the shower panel proximate a bottom of the sidewall; and the shower apparatus includes a gripping area located on the sidewall on the left side of the shower panel.

In a feature, the shower apparatus further comprises a shelf or tray attached to a side of the mounting component.

In a feature, the shower apparatus further comprises a shelf or tray attached to a side of the shower panel.

In a feature, the shelf or tray is attached to a side of the shower apparatus, and wherein the attachment of the shelf or tray is accomplished by way of a shelf door or slot located in a sidewall of the mounting component or of the shower panel.

In a feature, the mounting component includes a slot opening or drainage port for draining water that may leak into the mounting component.

In a feature, the shower panel includes a slot opening or drainage port for draining water that may leak into the shower panel.

In a feature, the shower panel includes a drainage port located in the lowermost area of the distal curved end portion, whereby water may drain therefrom in case of any leakage in the distal curved end portion.

In a feature, the shower apparatus comprises a single arrangement of sprayers, spray arrays, or spray patterns, which arrangement is located at the lower portion of the shower panel. The single arrangement may be in a “U” shaped pattern and extends around the bottom area of the water flow control assembly; or the single arrangement may be “in-line” with a vertical, single-column array of buttons of the water flow control assembly.

In another aspect, a shower apparatus comprises: (a) a water flow control assembly, itself comprising (i) a plurality of buttons, (ii) a constrained strip, and (iii) a plurality of valves or valve mechanisms, (iv) wherein each button when selected is intended to cause a corresponding one of the valve mechanisms to permit water to flow to a different grouping of one or more spray arrangements of the shower apparatus, whereby the water flow control assembly is able to cause a single, exclusive flow out of a plurality of possible flows; and (b) a faucet mechanism configured to enable a user to adjust an amount of water flowing to the water flow control assembly as well as the temperature of the water by varying between different hot and cold water flows that combine into the water flow to the water flow control assembly.

In a feature, the constrained strip comprises a number of hinged elements.

In a feature, the constrained strip comprises a single sheet of material.

In a feature, the constrained strip comprises a single sheet of spring steel.

In a feature, the constrained strip comprises plastic.

In a feature, the constrained strip is only long enough to have one deflection over its constrained length.

In a feature, the depressing of one of the buttons causes a defection of the constrained strip at that location, straightening the strip at all other locations, the deflection in the strip at that location engaging and acting on a valve mechanism to open the valve, thereby permitting fluid flow therethrough.

In a feature, the shower apparatus further comprises a shaft collar for setting a maximum height of the button upon return due to a spring force after being depressed. The faucet mechanism may comprise a water shut-off valve.

In a feature, the shower apparatus further comprises a water input line; a water input manifold; a water output manifold; and a plurality of water output lines. Furthermore, the shower apparatus may further comprise an inverted Y-juncture for combining flows in two of the water output lines.

In another aspect, a water flow control assembly for a shower apparatus comprises a plurality of buttons, a constrained strip; and a plurality of valves or valve mechanisms. Each button when selected is intended to cause a corresponding one of the valve mechanisms to permit water to flow therethrough and to cause a previously open valve mechanism to close, whereby water flow through the control assembly is limited to flow through a single, exclusive valve mechanism.

In a feature, the constrained strip comprises a number of hinged elements.

In a feature, the constrained strip comprises a single sheet of material.

In a feature, the constrained strip comprises a single sheet of spring steel.

In a feature, the constrained strip comprises plastic.

In a feature, the constrained strip is only long enough to have one deflection over its constrained length.

In a feature, the depressing of one of the buttons causes a defection of the constrained strip at that location, straightening the strip at all other locations, the deflection in the strip at that location engaging and acting on a valve mechanism to open the valve, thereby permitting fluid flow therethrough.

In a feature, the control assembly further comprises a shaft collar for setting a maximum height of the button upon return due to a spring force after being depressed.

Additional aspects and features are disclosed in the detailed description which follows. Still additional aspects and features of the invention are disclosed both in the Appendix to the specification, included herewith and incorporated herein by reference; and in the eDrawing model and the two video files of the computer program listing, all of which is incorporated herein by reference.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals.

FIG. 1 is a perspective view of a shower apparatus 100 in operation.

FIG. 2 is a front elevational view of the shower apparatus 100 of FIG. 1.

FIG. 3 illustrates a perspective view of the shower apparatus 100 of FIGS. 1 and 2.

FIG. 4 is a front elevational view of another shower apparatus 200 in accordance with another preferred embodiment of the invention.

FIG. 5 is a side elevational view of the shower apparatus 200.

FIG. 6 is a bottom plan view of the shower apparatus 200.

FIG. 7 is an elevational front view of the lower portion 210 of the shower apparatus 200.

FIG. 8 is a perspective view of the lower portion 210 of the shower apparatus 200.

FIG. 9 is a bottom plan view of the top portion 206 of the shower apparatus 200.

FIGS. 10-13 show in perspective views the shower apparatus 200 and serve to illustrates for contrast and comparison the shower apparatus 200 with the shower panel 204 thereof in each of four different positions.

FIG. 14 illustrates a perspective view of another shower apparatus 300 in accordance with another preferred embodiment of the invention

FIG. 15 is a partially exploded, perspective view of the shower apparatus 300.

FIG. 16 is a perspective view of the mounting bracket or mounting component 302 of the shower apparatus 300.

FIG. 17 illustrates a perspective view of another shower apparatus 400.

FIG. 18 is an elevational side plan view of the shower apparatus 400.

FIG. 19 is a bottom plan view of the shower panel 404 of the shower apparatus 400.

FIG. 20 is schematic perspective view of a water flow control assembly 1020 in accordance with a first illustrated preferred embodiment.

FIG. 21 schematically illustrates the constrained strip 1050 of the water flow control assembly 1020, which comprises a number of hinged elements.

FIG. 22 is a schematic elevational view of a portion of the control assembly 1020 showing a shaft collar 1090 that optionally may be used.

FIG. 23 is a perspective view of a water flow control assembly 1120 in accordance with another preferred embodiment, which control assembly has been actually reduced to practice.

FIG. 24 is a schematic illustration of a relationship between an input manifold and associated plumbing 1124, an output plumbing 1126, and the control assembly 1120.

FIG. 25 is a schematic elevational view of the control assembly 1120 and serves to illustrate the three general types of components of the control assembly, including the buttons generally indicated by 1130; the constrained strip 1150; and the valve mechanisms generally indicated by 1140.

FIG. 26 is a schematic illustration of a control mechanism that is able to cause a single exclusive flow out of four possible flows 1,2,3,4.

FIGS. 27, 28, and 28a are perspective views illustrating in greater detail the valve mechanisms 1140 used in the proof-of-concept control assembly 1124.

FIGS. 29-38 demonstrate the operation of the water flow control assembly 1120.

FIG. 39 is a front elevational view of a design for a preferred water flow control assembly 1220 and associated components.

FIG. 40 is an enlarged view of the water flow control assembly 1220 of FIG. 39.

FIG. 41 is a cross sectional view taken along the line 41-41 of the design of FIG. 39.

FIG. 42 is a cross-sectional view taken along the line 42-42 of the design of FIG. 39.

FIG. 43 is a side elevational view of the design of FIG. 39.

FIG. 44 is a back elevational view of the design of FIG. 39.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, while steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once during performance of the claimed method.

Furthermore, it is important to note that, as used herein, “a” and “an” each generally denotes “at least one”, but does not exclude a plurality unless the contextual use dictates otherwise. Thus, reference to “a picnic basket having an apple” describes “a picnic basket having at least one apple” as well as “a picnic basket having apples”. In contrast, reference to “a picnic basket having a single apple” describes “a picnic basket having only one apple”.

When used herein to join a list of items, “or” denotes “at least one of the items”, but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”. When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”.

Referring now to the drawings, one or more preferred embodiments of the invention are next described. The following description of one or more preferred embodiments is merely exemplary in nature and is in no way intended to limit the invention, its implementations, or uses.

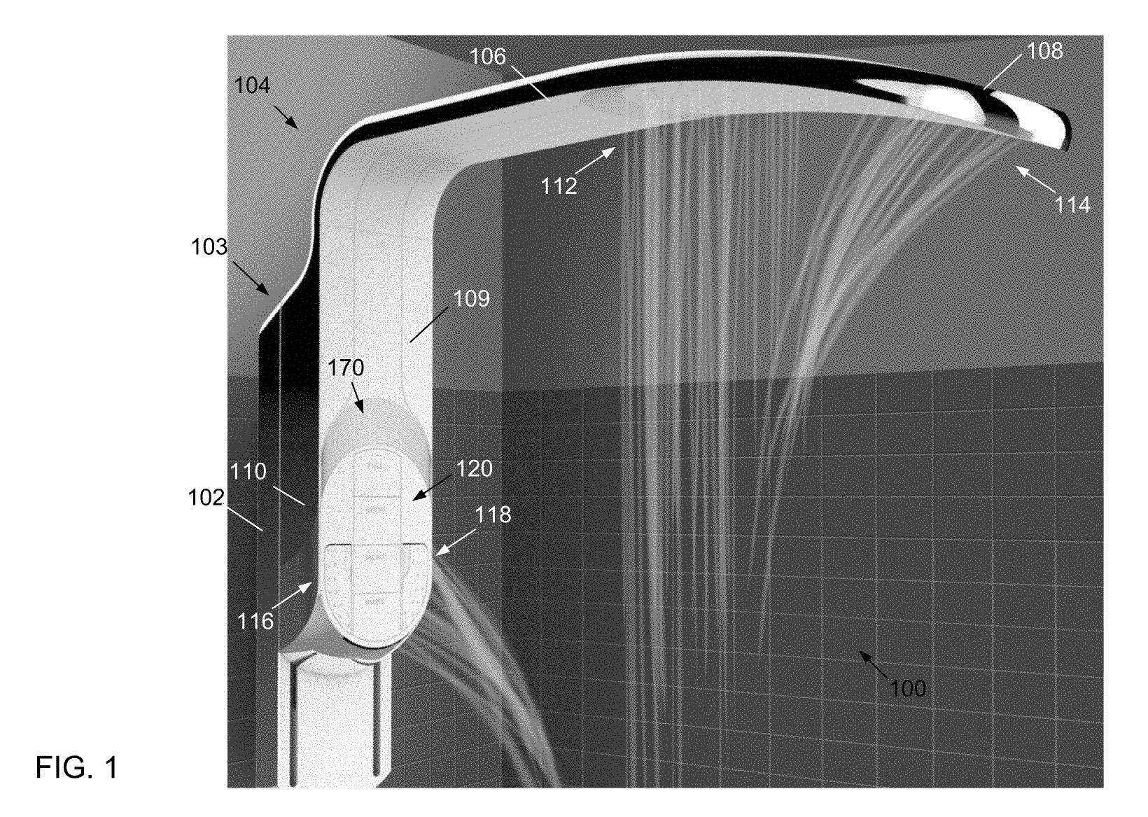

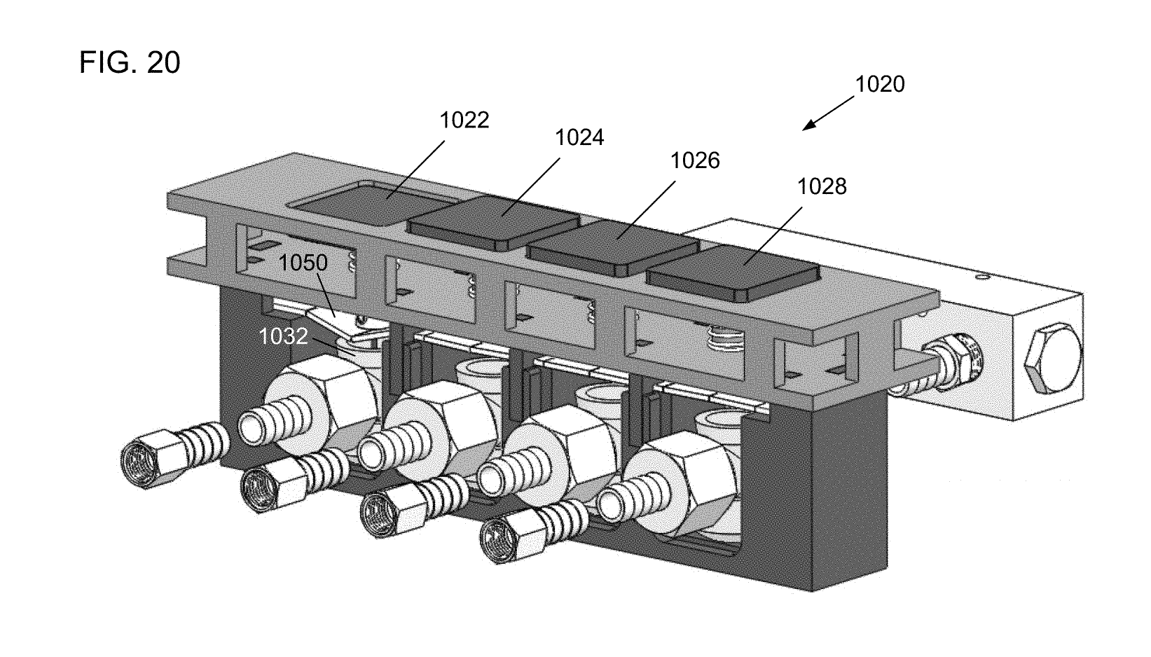

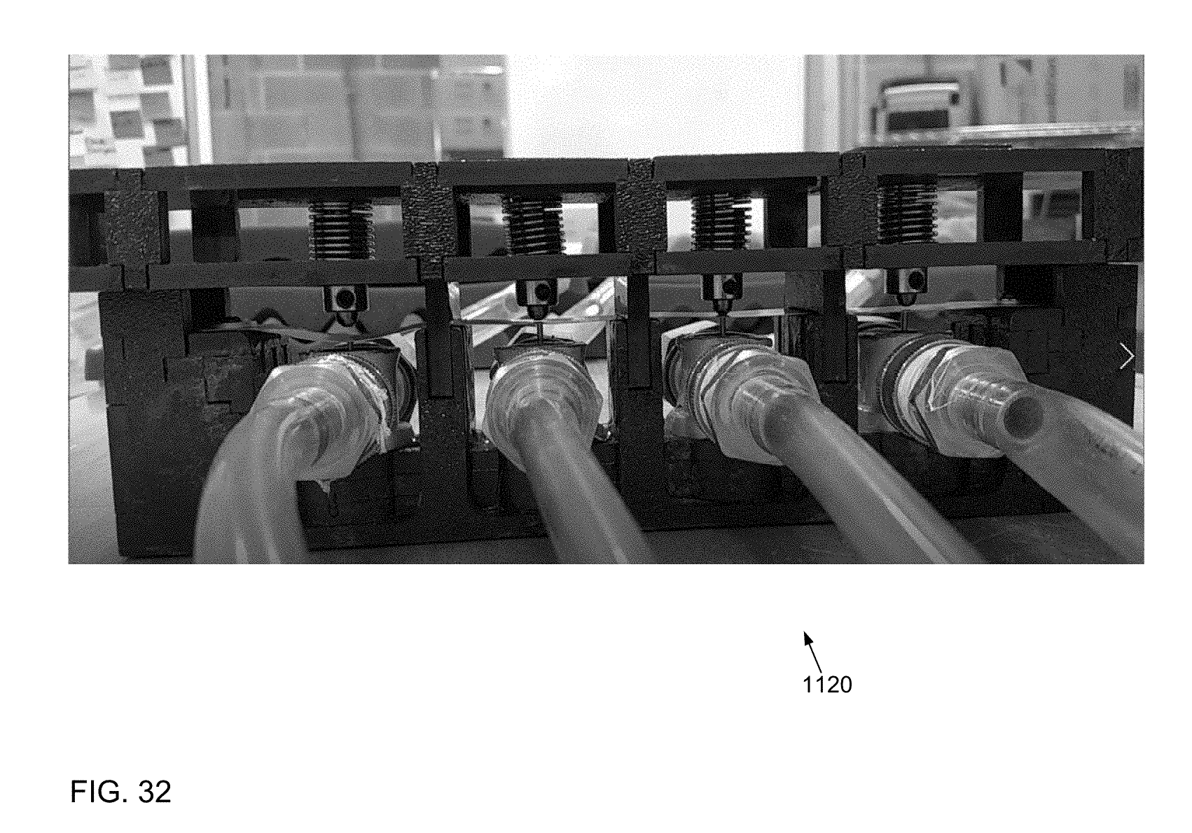

Furthermore, it will be understood that FIGS. 1-19 disclose various preferred embodiments of shower apparatus in accordance with one or more aspects and features of the present invention; and that FIGS. 20-44 disclose various preferred embodiments—and a proof-of-concept embodiment—of water flow control assemblies in accordance with one or more aspects and features of the present invention, which water flow control assemblies preferably are used with the preferred showered apparatus described with reference to FIGS. 1-19.

### Shower Apparatus: First Illustrated Preferred Embodiment

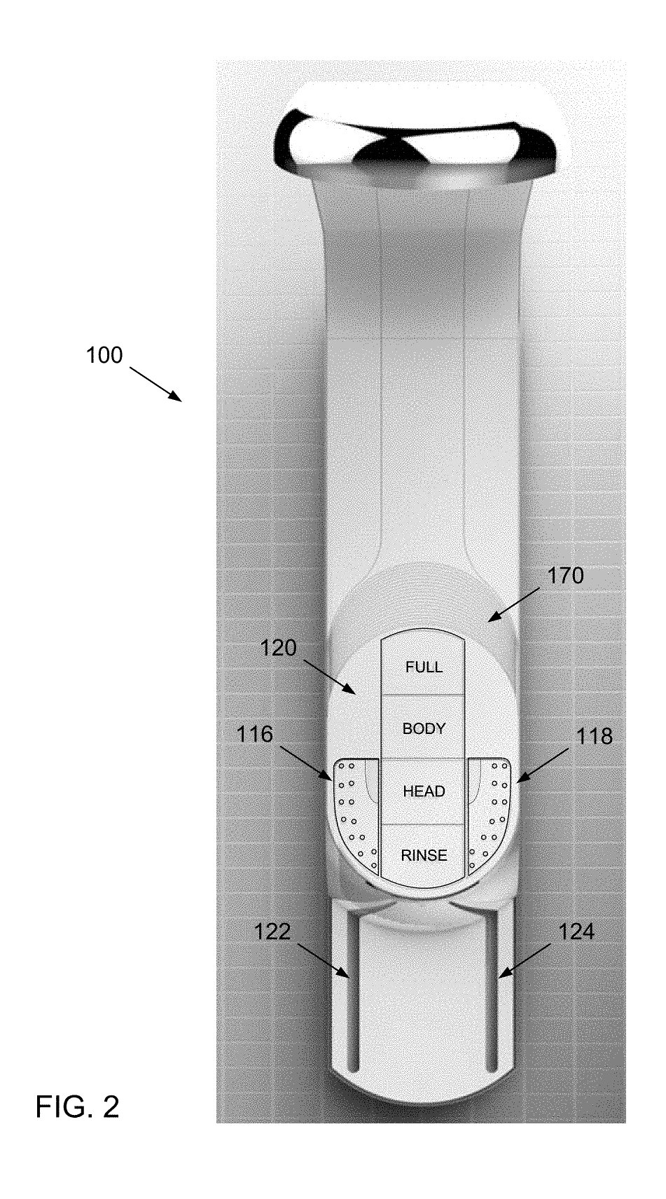

Turning to FIGS. 1 and 2, FIG. 1 is a perspective view of a shower apparatus 100 in operation, having been installed in a tiled shower area; and FIG. 2 is a front elevational view of the shower apparatus 100 of FIG. 1. The shower apparatus 100 is in accordance with a preferred embodiment of the invention, and embodies one or more aspects and features of the invention.

The shower apparatus 100 comprises a mounting bracket or mounting component 102 and a rigid component that generally may be characterized as a shower panel 104. The shower panel 104 comprises one or more arrangements of sprayers (which may be referred to as “spray arrays” or “spray patterns”), and fluid passageways connecting water input to the one or more arrangements of sprayers. Each sprayer may comprise a nozzle, or even simply a small opening for creating a mini jet stream of pressurized water, and each fluid passageway may comprise piping, tubes, or other fluid conduits. The mounting component 102 is mounted to a wall of the tiled shower area. The shower panel 104 is attached to the mounting component 102 and is configured to transition—preferably by sliding—to different positions at different heights. Furthermore, the shower panel 104 preferably is lockable in each position, whereby the one or more arrangements of sprayers located on the shower panel 104—which is rigid—are all commonly adjustable for accommodating persons of different heights for taking showers.

As seen in FIGS. 1 and 2, the shower panel 104 is locked at an upper position, in which position the exterior top surfaces of the mounting component 102 and the shower panel 104 align at 103 to form a continuous curvature of an upper portion of the shower apparatus 100 when in such position.

The preferred arrangements of sprayers of the shower apparatus 100 correspondingly comprise an uppermost arrangement 112 of sprayers, located on a top portion 106 of the shower panel 104; a second arrangement 114 of sprayers located on a curved distal end portion 108 of the shower panel 104 at an elevation below the uppermost arrangement 112; and one or more lowermost arrangements of sprayers. The one or more lowermost arrangements of sprayers are seen in FIGS. 1 and 2 to comprise third and fourth arrangements 116,118 of sprayers located on a lower portion 110 of the shower panel 104 on opposites lateral sides of a water flow control assembly 120, with a rigid neck portion 109 of the shower panel 104 extending upwardly between and interconnecting the lower portion 110 and the top portion 106 of the shower panel 104. As shown, the arrangements 116,118 are symmetrically arranged on opposite sides of the water flow control assembly 120 relative to a vertical axis of the neck portion 109.

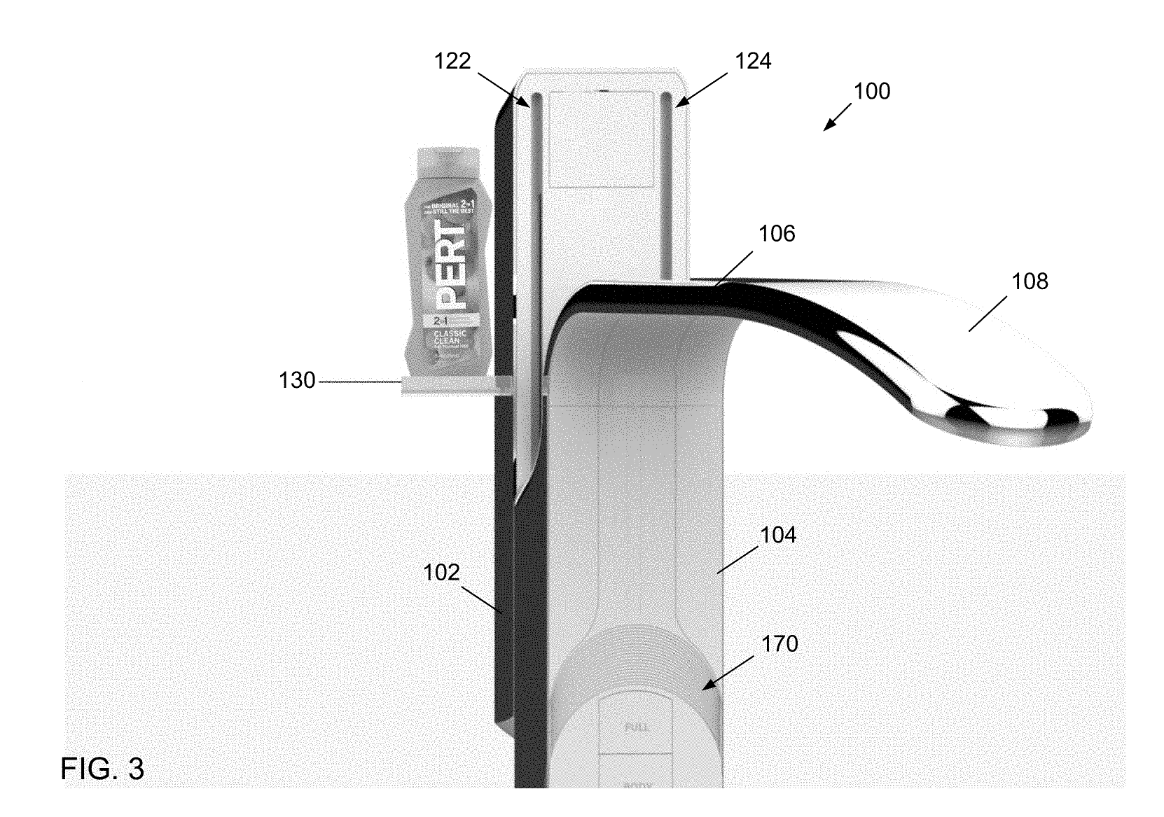

As perhaps best seen in FIG. 2, the shower panel 104 is connected to and slides relative to the mounting component 102 through slots 122,124 that vertically extend along a surface of the mounting component 102 between proximate a bottom of the mounting component 102 (as seen in FIG. 2), to proximate a top of the mounting component 102 (as seen in FIG. 3, described below).

As also perhaps best seen in FIG. 2, the water flow control assembly 120 preferably includes four push buttons vertically aligned in a single column array. These four push buttons comprise, from top to bottom: a “FULL” button, by which water flows to all of the sprayers of the arrangements 112,114,116,118; a “BODY” button, by which water flows to only the sprayers of the arrangements 114,116,118; a “HEAD” button, by which water flows only to the sprayers of the arrangement 112; and a “RINSE” button, by which water flows only to the sprayers of the arrangements 116,118. Moreover, additional or fewer buttons for flow to different combinations of the arrangements of sprayers may be included within the scope of the contemplated invention; the four buttons illustrated are considered preferred for at least some embodiments of the invention.

A shower apparatus—and specifically a shower panel of the shower apparatus—further preferably comprises one or more gripping areas that are configured to facilitate frictional gripping by a person of the shower panel when manually sliding the shower panel for height adjustment. A gripping area may be formed by applying a pattern of silicone to and slightly extending above the surface of the shower panel, such as through molding of silicone onto the shower panel. A gripping area alternatively may be formed by applying an adhesive decal or patch having an exposed surface area facilitating frictional gripping. The shower apparatus 100 includes a gripping area 170 extending between opposite sides of the shower panel above the push buttons of the water flow control assembly 120.

FIG. 3 illustrates a perspective view of the shower apparatus 100 of FIGS. 1 and 2, wherein the shower panel 104 is seen to have been slid to and locked in a lowermost position, in which position the exterior bottom surfaces of the mounting component 102 and the shower panel 104 do not align to form a continuous curvature of a bottom of the shower apparatus 100 when in such position. Instead, the bottom surface of the shower panel 104 is located at an elevation below the elevation of the bottom surface of the mounting component 102.

Furthermore, a shelf or tray 130 is seen attached to a side of the mounting component 102. The tray 130 preferably is configured to support soap, shampoo, or one or more other items used when showering. It will be appreciated that transitioning of the shower panel 104 results in adjustment of respective heights of each of the arrangements 112,114,116,118 of sprayers as well as height of the water flow control assembly 120; however, the height of the tray 130 remains fixed, as the mounting component 102 is secured at a fixed elevation on the tiled wall. In alternative contemplated embodiments, a tray instead attaches to a side of the shower panel 104. Additionally, while shown attached to the left side of the shower apparatus 100 in FIG. 3 the tray may be attached to the other side of the shower apparatus in other embodiments, or may be detachable and reattachable to either side of the shower apparatus in still other embodiments.

### Shower Apparatus: Second Illustrated Preferred Embodiment

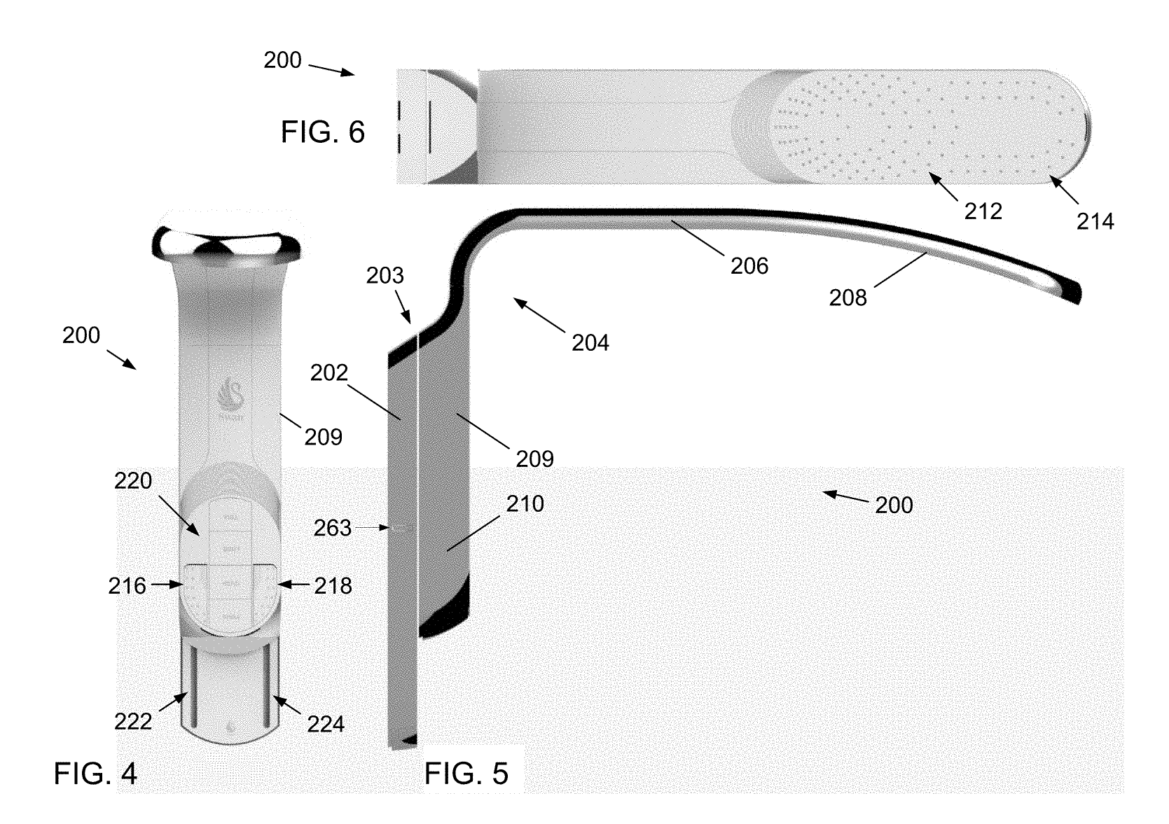

FIG. 4 is a front elevational view of another shower apparatus 200 in accordance with another preferred embodiment of the invention, and is similar in structure to shower apparatus 100. Additionally, FIG. 5 is a side elevational view of the shower apparatus 200, and FIG. 6 is a bottom plan view of the shower apparatus 200.

The shower apparatus 200 comprises a mounting component 202 and a rigid component that generally may be characterized as a shower panel 204. The shower panel 204 comprises one or more arrangements of sprayers and fluid passageways connecting water input to the one or more arrangements of sprayers. The mounting component 202 is configured to be mounted to a wall of a shower area, and the shower panel 204 is attached to the mounting component 202 and is configured to transition—preferably by sliding—to different positions at different heights when the mounting component 202 is mounted on a wall. Furthermore, the shower panel 204 preferably is lockable in each position, whereby the one or more arrangements of sprayers located on the shower panel 204—which is rigid—are all commonly adjustable for accommodating persons of different heights for taking showers. As seen in FIG. 5, the shower panel 204 has been slid to and locked in an upper position, in which position the exterior top surfaces of the mounting component 202 and the shower panel 204 align at 203 to form a continuous curvature of an upper portion of the shower apparatus 200 when in such position.

The preferred arrangements of sprayers of the shower apparatus 200 correspondingly comprise an uppermost arrangement 212 of sprayers, located on a top portion 206 of the shower panel 204; a second arrangement 214 of sprayers located on a curved distal end portion 208 of the shower panel 204 at an elevation below the uppermost arrangement 212; and one or more lowermost arrangements of sprayers. The one or more lowermost arrangements of sprayers are seen in FIG. 4 to comprise third and fourth arrangements 216,218 of sprayers located on a lower portion 210 of the shower panel 204 on opposites lateral sides of a water flow control assembly 220, with a rigid neck portion 209 of the shower panel 204 extending upwardly between and interconnecting the lower portion 210 and the top portion 206 of the shower panel 204. As shown, the arrangements 216,218 are symmetrically arranged on opposite sides of the water flow control assembly 220 relative to a vertical axis of the neck portion 209.

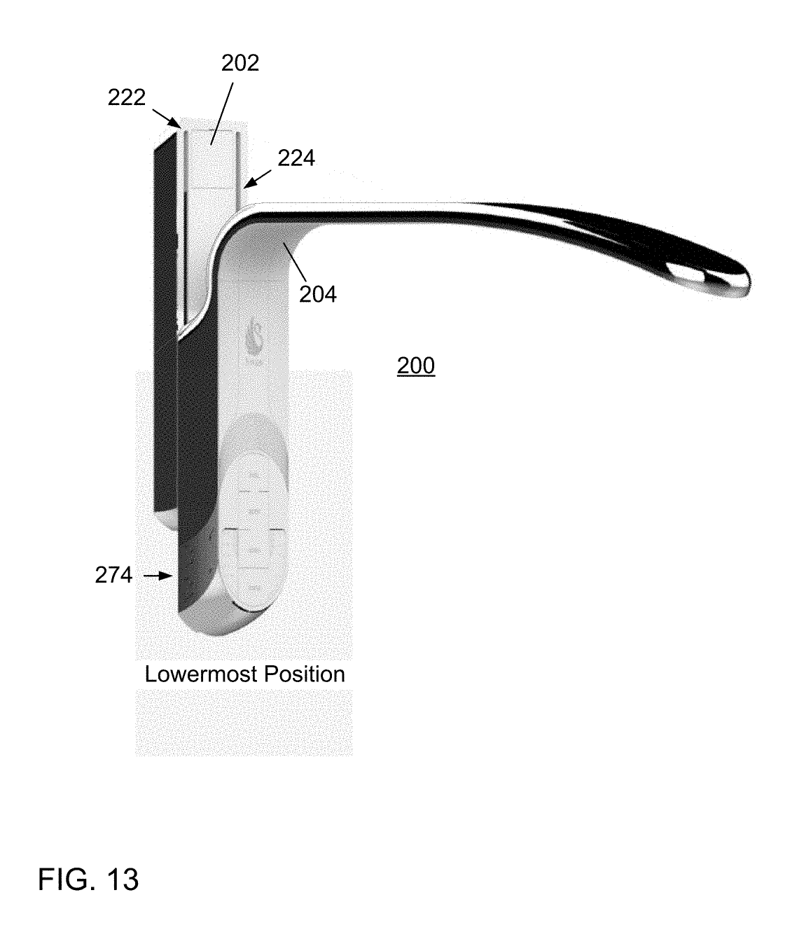

As seen in FIG. 4, the shower panel 204 is connected to and slides relative to the mounting component 202 through slots 222,224 that vertically extend along a surface of the mounting component 202 between proximate a bottom of the mounting component 202 (as seen in FIG. 4), to proximate a top of the mounting component 202 (as seen in FIG. 13, described below).

FIG. 6 shows the arrangement 212 of sprayers of the top portion 206 in comparison to the sprayers 214 of the distal curved end portion 208 in the shower apparatus 200.

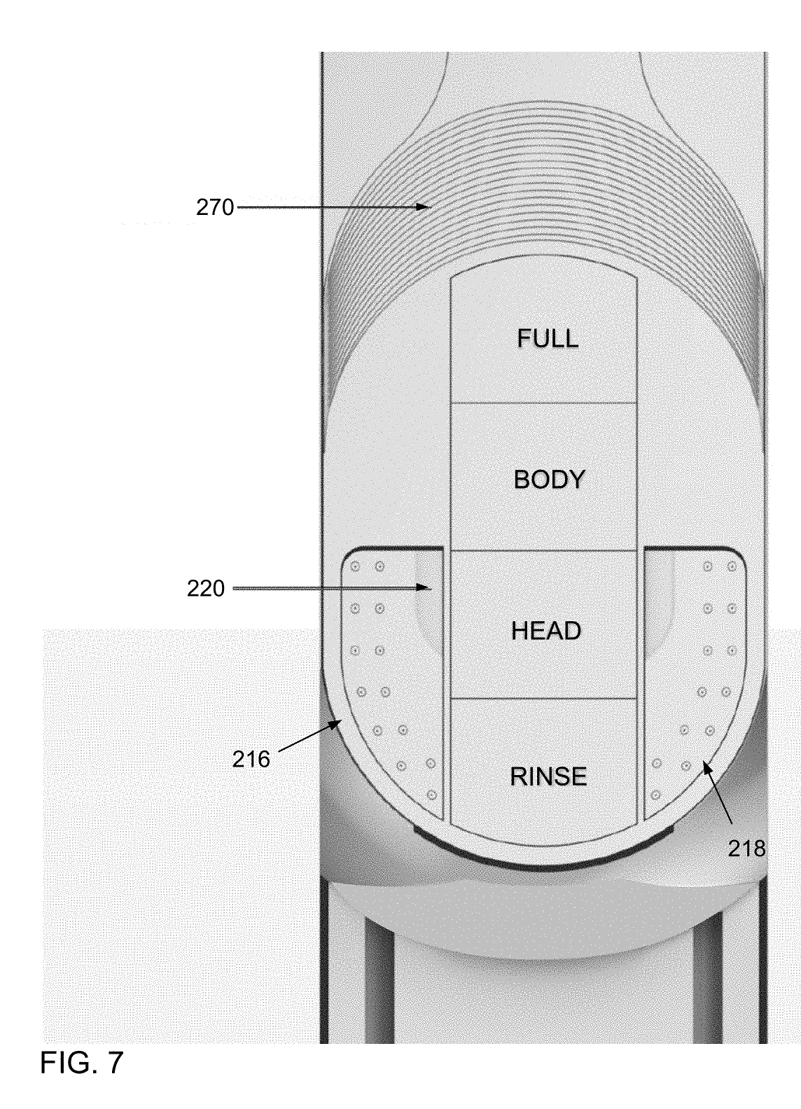

As perhaps best seen in FIG. 7, which is an elevational front view of the lower portion 210 of the shower apparatus 200, the water flow control assembly 220 of shower apparatus 100 preferably includes four push buttons corresponding to those of the waterflow control assembly 120 of shower apparatus 100. Of course, additional or fewer buttons for flow to different combinations of the arrangements of sprayers may be included within the scope of the contemplated invention; the four buttons illustrated are considered preferred for at least some embodiments of the invention.

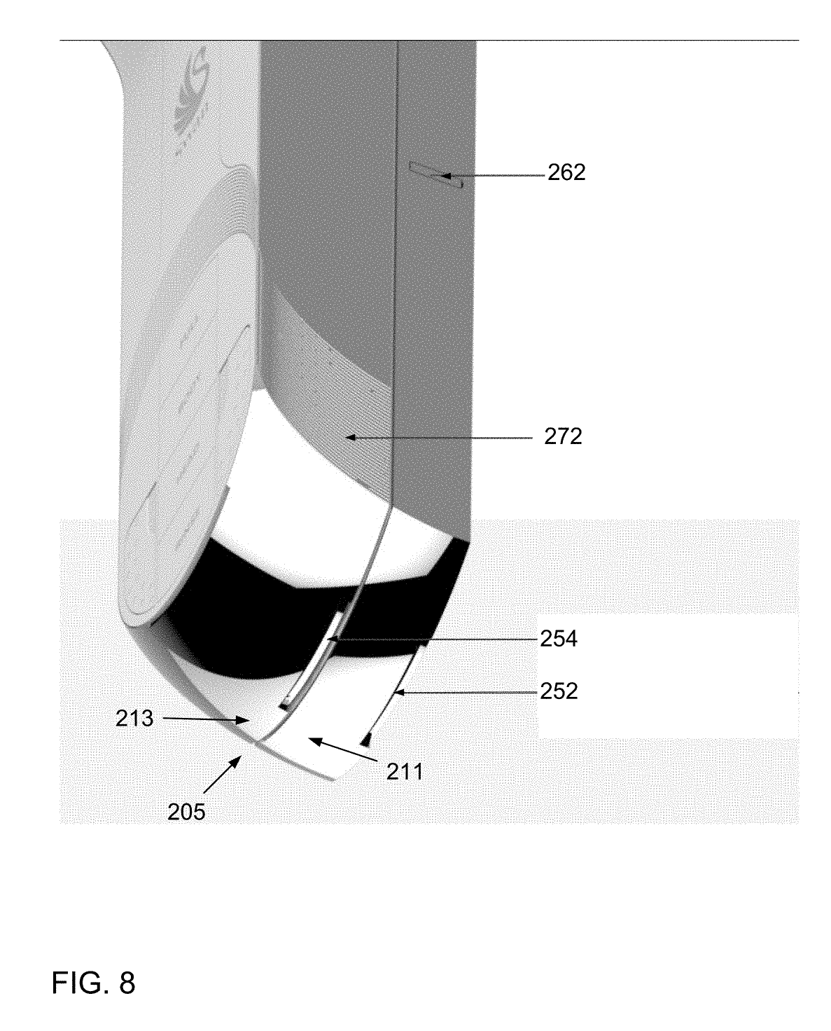

FIG. 8 is a perspective view of the lower portion 210 of the shower apparatus 200, wherein the shower panel 204 is seen to have been slid and locked into a lower position, in which position the exterior bottom surface 211 of the mounting component 202 and the exterior bottom surface 213 of the shower panel 204 align at 205 to form a continuous curvature of a bottom of the shower apparatus 200 when in such position.

As additionally seen in FIG. 8, the mounting component 202 includes a slot opening or drainage port 252 for draining water that may leak into the mounting component, and the shower panel 204 includes a slot opening or drainage port 254 for draining water that may leak into the shower panel 204, as seals may weaken over extended periods of time or water connections may come loose.

A shelf or tray (not shown with shower apparatus 200) may be attached to a side of the shower apparatus 200, similarly as seen in FIG. 3 with respect to the shower apparatus 100. Attachment of the tray preferably is accomplished by way of a shelf door or slot 262 located in a sidewall of the mounting component 202, which is perhaps best seen in FIG. 8. Of course, such a slot may be located in the sidewall on the other side of the mounting component 202—shown for example at 263 in FIG. 5, or located in a sidewall of the shower panel 204, in accordance with various embodiments of the invention.

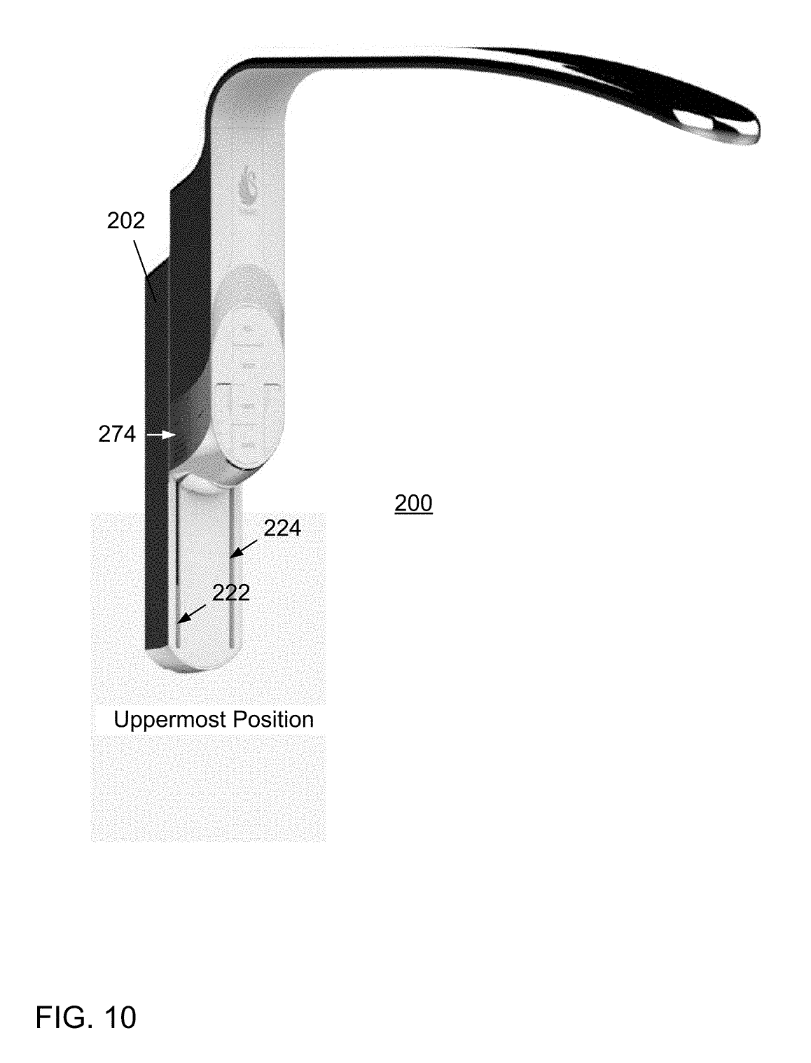

With reference to both FIG. 7 and FIG. 8, the shower apparatus 200 is seen to include a gripping area 270 extending between opposite sides of the shower panel 204 around an upper area of the push buttons of the water flow control assembly 220; and a gripping area 272 located on the sidewall on the right side of the shower panel 204 proximate a bottom of the sidewall. A similar gripping area 274 (shown in FIGS. 10-13) is likewise located on the sidewall on the left side of the shower panel 204.

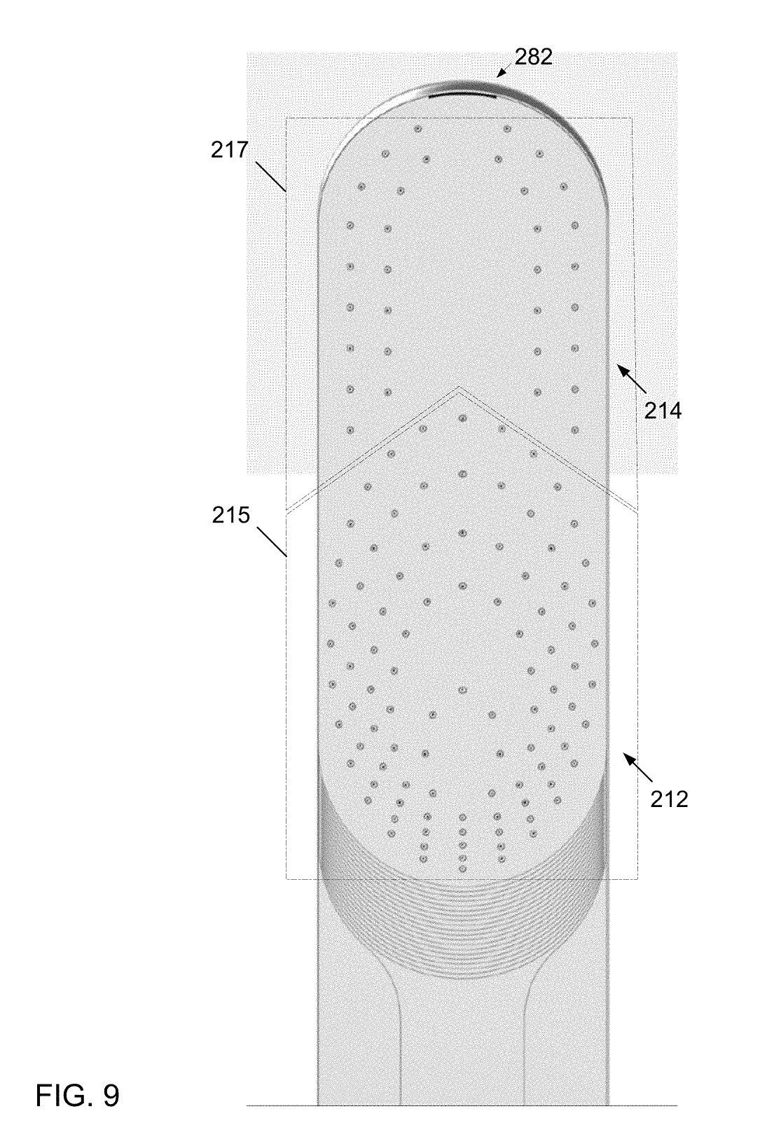

FIG. 9 is a bottom plan view of the top portion 206 of the shower apparatus 200 that perhaps best shows the arrangement 212 of sprayers of the top portion 206 in comparison to the sprayers 214 of the distal curved end portion 208 in the shower apparatus 200; the arrangement 212 of sprayers are found within the outlined area 215, and the arrangement 214 of sprayers are found within the outlined area 217.

FIG. 9 also shows a drainage port 282 located in the lowermost area of the distal curved end portion 208, whereby water may drain therefrom in case of any leakage in the distal curved end portion 208. Indeed, water that may leak in the distal curved end portion 208 preferably exits through drainage port 282, whereas water leaking elsewhere within the shower panel 204 preferably exits through drainage port 254.

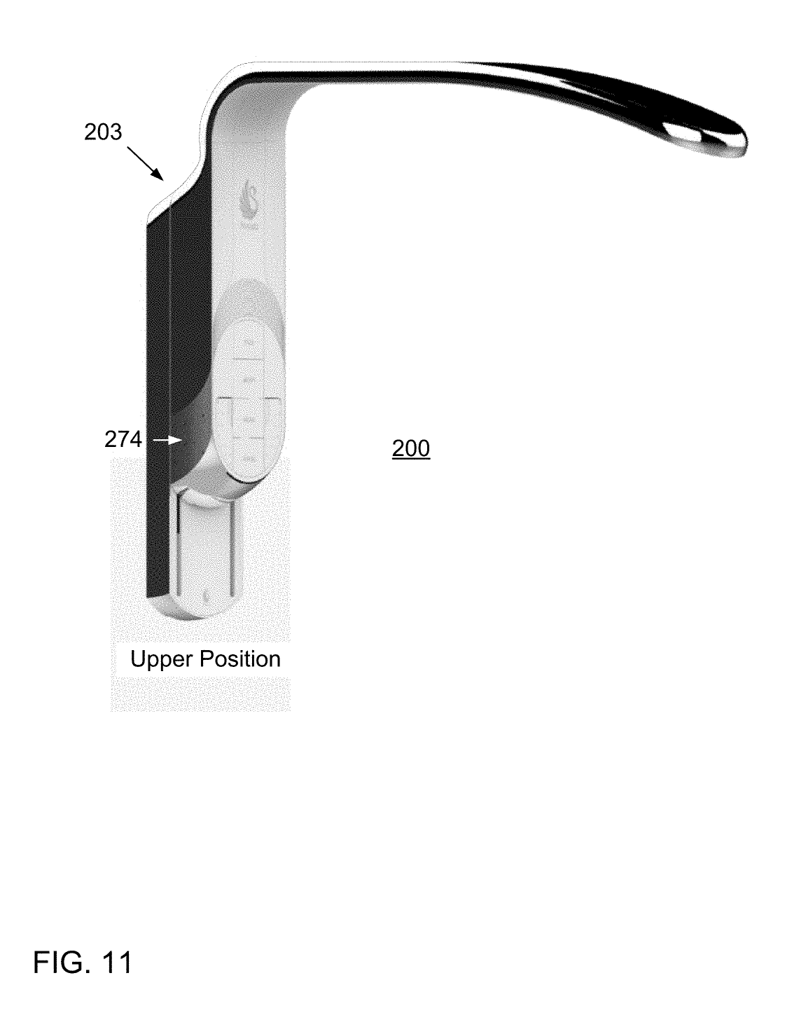

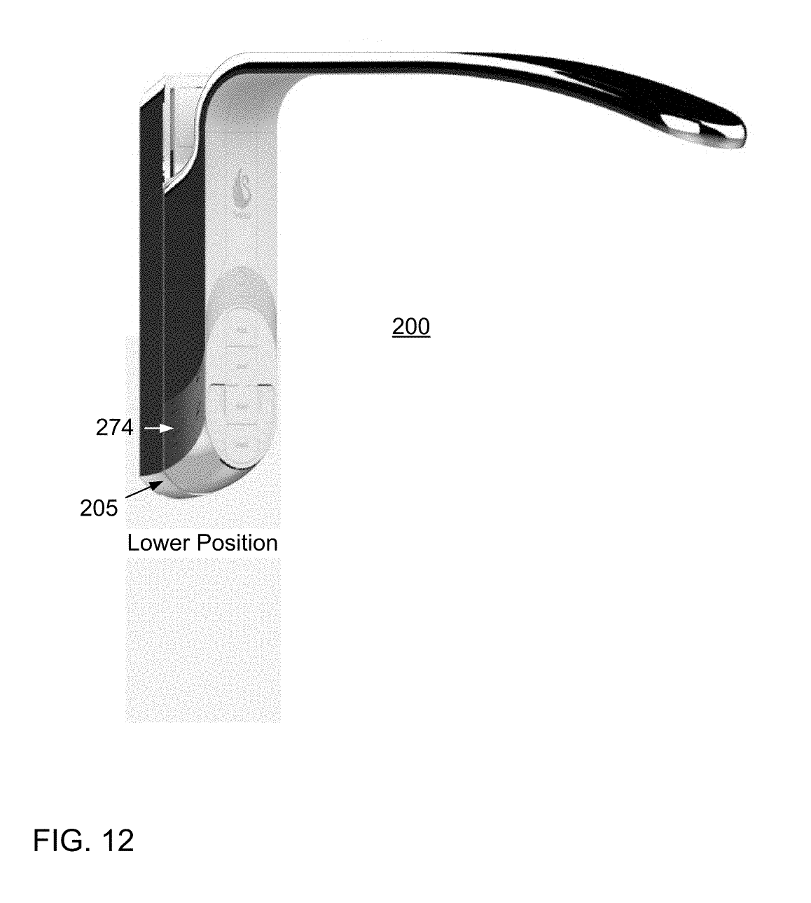

FIGS. 10-13 show in perspective views the shower apparatus 200 and serve to illustrates for contrast and comparison the shower apparatus 200 with the shower panel 204 thereof in each of four different positions to which the shower panel 204 is transitionable and preferably lockable. In FIG. 10 the shower panel 204 is seen to have been slid to and is locked in an uppermost position; in FIG. 11 the shower panel 204 is seen to have been slid to and is locked in an upper position; in FIG. 12 the shower panel 204 is seen to have been slid to and is locked in a lower position; and in FIG. 13 the shower panel 204 is seen to have been slid to and is locked in a lowermost position.

### Shower Apparatus: Third Illustrated Preferred Embodiment

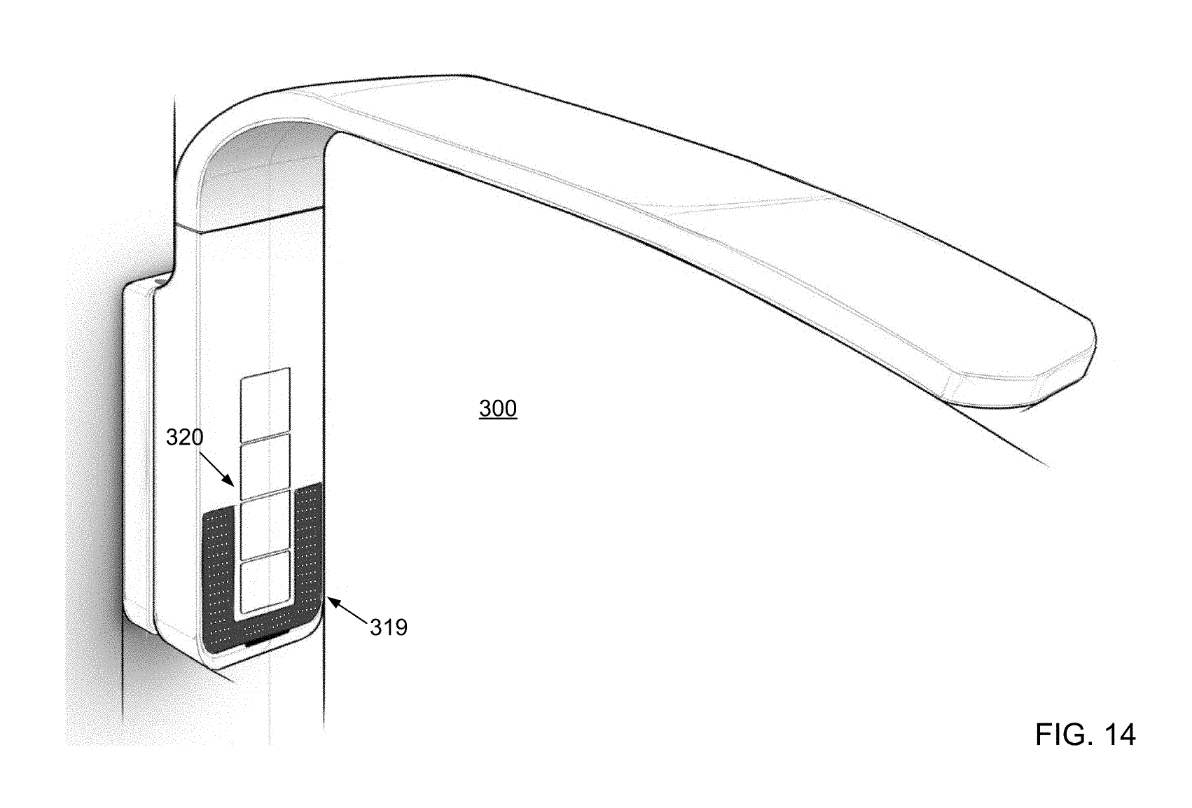

FIG. 14 illustrates a perspective view of another shower apparatus 300 in accordance with another preferred embodiment of the invention, and is similar in structure to shower apparatus 100,200; however, one differentiation is that shower apparatus 300 comprises a single arrangement 319 of sprayers located at the lower portion of the shower panel 304. This single arrangement 319 is in a “U” shaped pattern and extends around the bottom area of the water flow control assembly 320. This single arrangement 319 is in contrast to the separate arrangements 116,118 of sprayers.

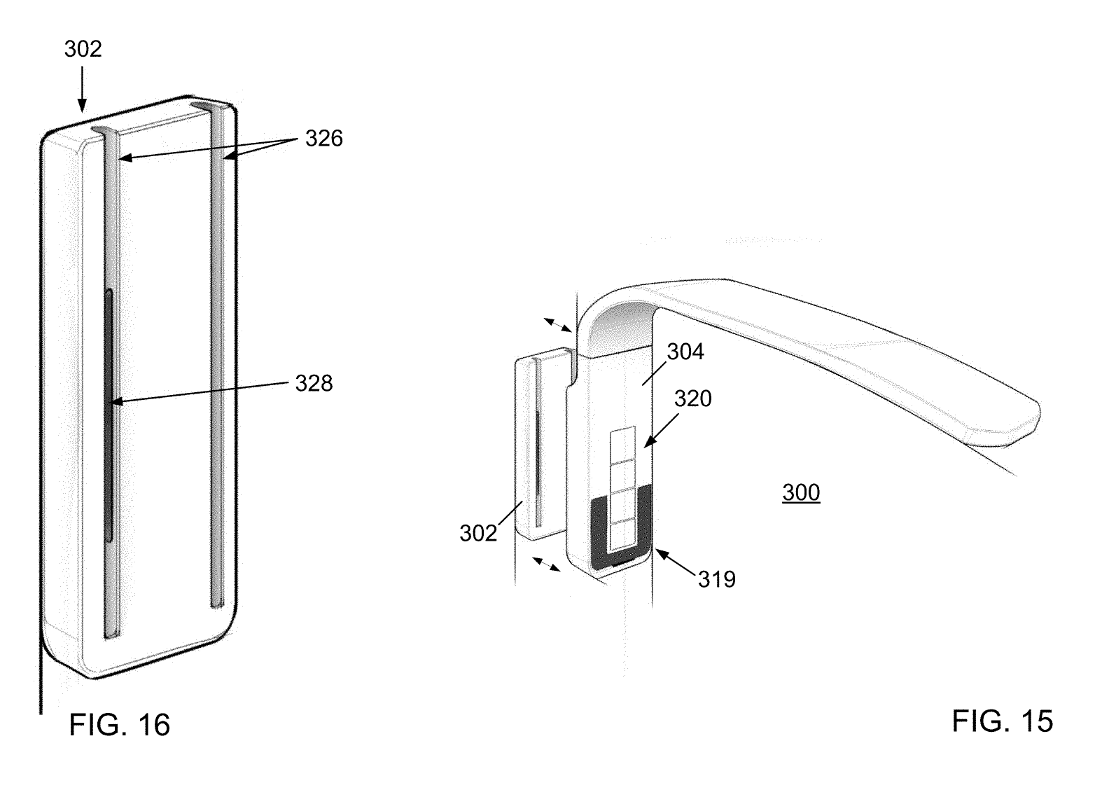

FIG. 15 is a partially exploded, perspective view of the shower apparatus 300; and FIG. 16 is a perspective view of the mounting bracket or mounting component 302 of the shower apparatus 300. The mounting component 302 comprises dual friction support tracks 326. The mounting component 302 also comprises a water pipe exit slot 328 that constitutes a water input to the water flow control assembly 320, described in detail below.

### Shower Apparatus: Fourth Illustrated Preferred Embodiment

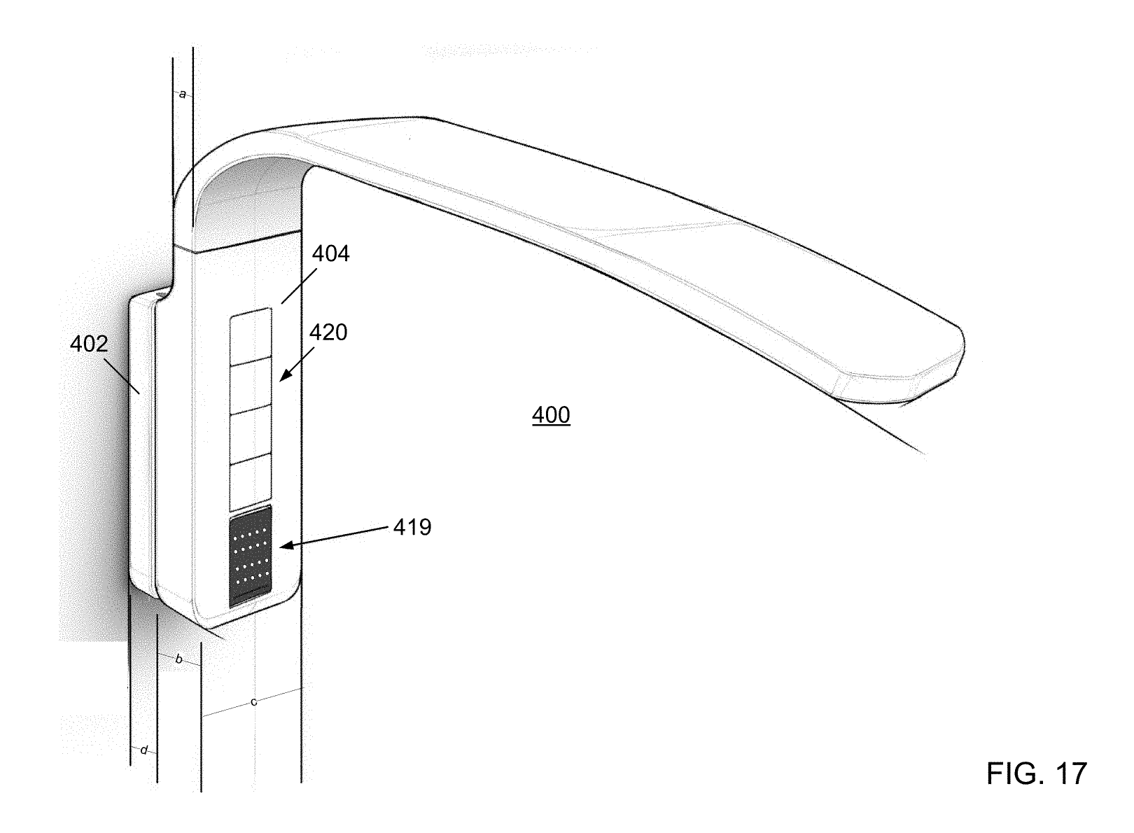

FIG. 17 illustrates a perspective view of another shower apparatus 400 similar to shower apparatus 300 having a single arrangement 419 of sprayers located at the lower portion of the shower panel. In shower apparatus 400, the arrangement is “in-line” with a vertical, single-column array of push buttons of the water flow control assembly 420. FIG. 17 also illustrates some preferred dimensions of a shower apparatus, wherein an upper depth a of the shower panel 404 is 1.5 inches; a lower depth b of the shower panel 404 is 3 inches; a width c of the shower panel 404 (and corresponding width of the bracket component 402) is between 6 and 6.5 inches; a depth d of the mounting bracket 402 is 1.5 inches.

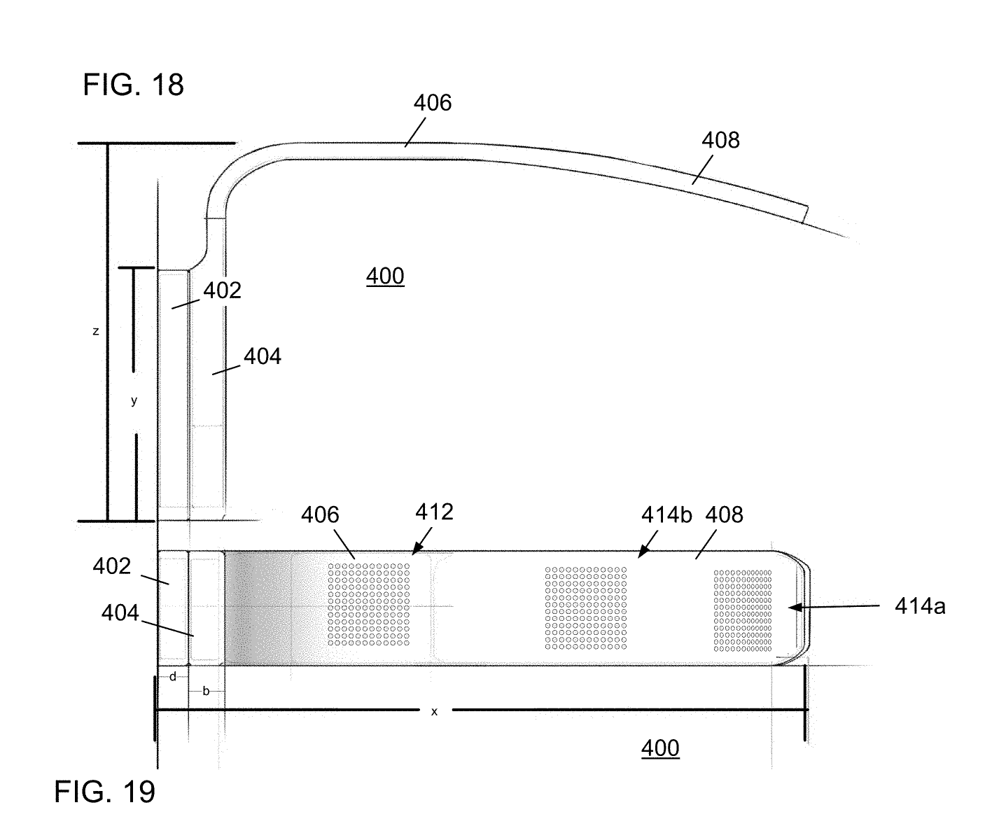

FIG. 18 is an elevational side plan view of the shower apparatus 400 and shows that a preferred overall vertical height z of the shower apparatus 400 is 23 inches and that a preferred vertical height y of the mounting bracket 402 is 16 inches. FIG. 18 further shows a side profile of the shower panel 404 revealing the top portion 406 thereof in contrast to the distal curved end portion 408. It will be appreciated that the top portion 406 and distal curved end portion 408 of the shower panel 402 is cantilevered.

FIG. 19 is a bottom plan view of the shower panel 404 of the shower apparatus 400 and shows that a preferred overall length x (i.e., extension from a wall to which the mounting bracket 402 is mounted) is 36.5 inches. FIG. 19 also shows an upper most arrangement 412 of sprayers located along the top portion 406, and additional arrangements 414a,414b of sprayers located at lesser elevations long the distal curved end portion 408 of the shower panel 404.

### Water Flow Control Assembly: First Illustrated Preferred Embodiment

With reference now to FIGS. 20-44, one or more preferred embodiments of a water flow control assembly in accordance with preferred embodiments of the invention will now be described, which embody one or more of inventive aspects and features.

FIG. 20 is schematic perspective view of a water flow control assembly 1020 in accordance with a first illustrated preferred embodiment. The water flow control assembly 1020 comprises push buttons 1022,1024,1026,1028, each of which is intended to activate a particular shower setting and disable all others shower settings at the push of a button. In this respect, actual water flow to a shower apparatus preferably is controlled by a conventional faucet mechanism, which enables a user to adjust the amount of water flowing as well as the temperature of the water by varying between different hot and cold water flows that combine into the water flow to the shower apparatus. The control assembly 1020 is used to direct that combined water flow to the desired one or more arrangements of sprayers.

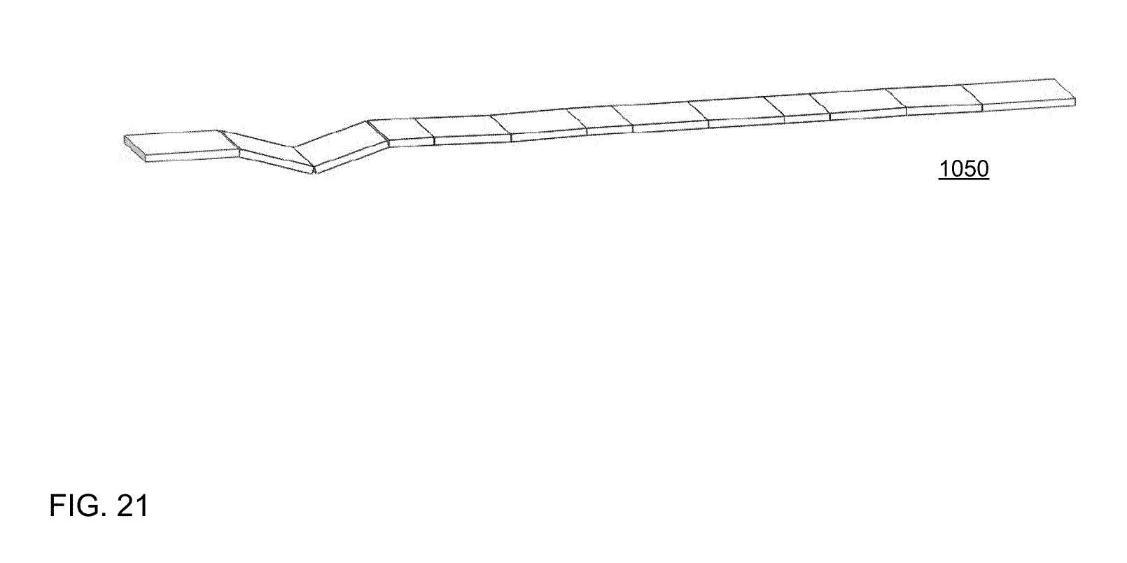

FIG. 21 schematically illustrates the constrained strip 1050 of the water flow control assembly 1020, which comprises a number of hinged elements.

In operation, the control assembly 1020 uses a constrained strip 1050 of material that is only long enough to have one area of deflection over its constrained length. Pushing one of the buttons causes a deflection at that location, straightening the strip at all other locations. The deflection in the strip at that location engages and acts on a valve mechanism to open the valve, permitting fluid flow therethrough. Since all other portions of the strip 1050 are straightened, the other valves are and remain closed and block fluid flow therethrough. For example, as seen in FIG. 20, push button 1022 is depressed, causing strip 1050 to deflect and activate corresponding valve 1032 to permit water flow therethrough, and causing all other valves associated with the other push buttons to be closed and cutting off water flow therethrough.

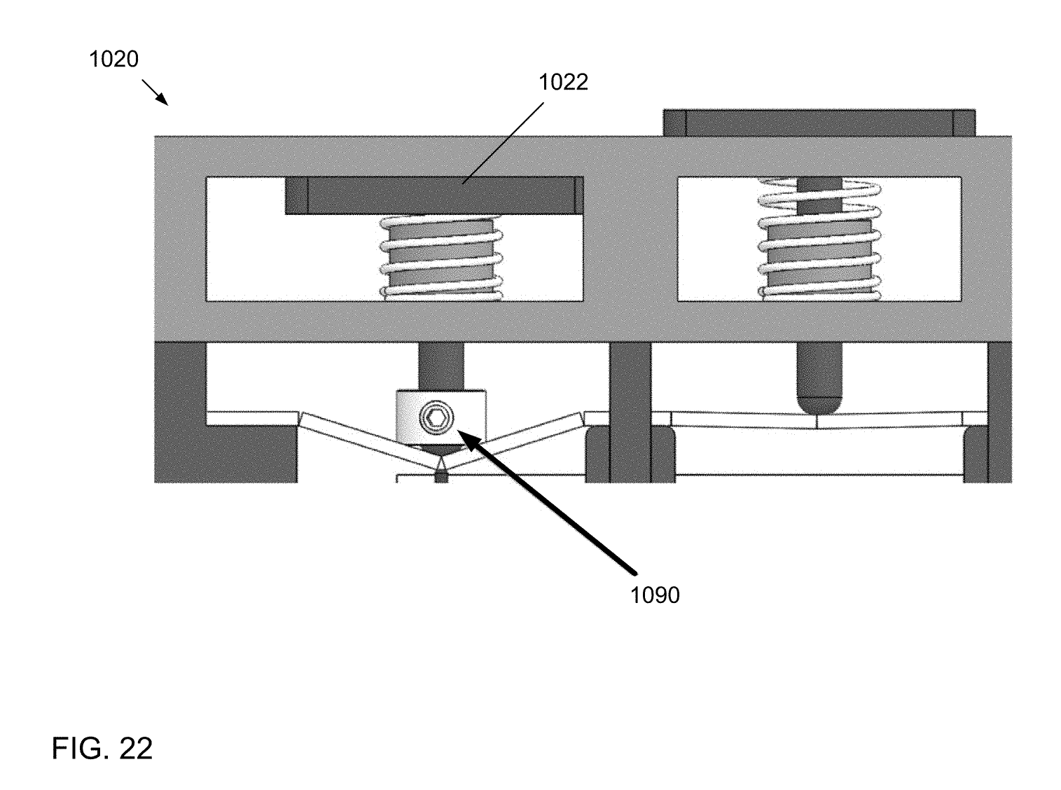

FIG. 22 is a schematic elevational view of a portion of the control assembly 1020 showing a shaft collar 1090 that optionally may be used in the control assembly 1020 for setting a maximum height of the button 1022 upon its upward return after being depressed. Such shaft could similarly be used with the other buttons, too.

### Water Flow Control Assembly: Second Illustrated Preferred Embodiment

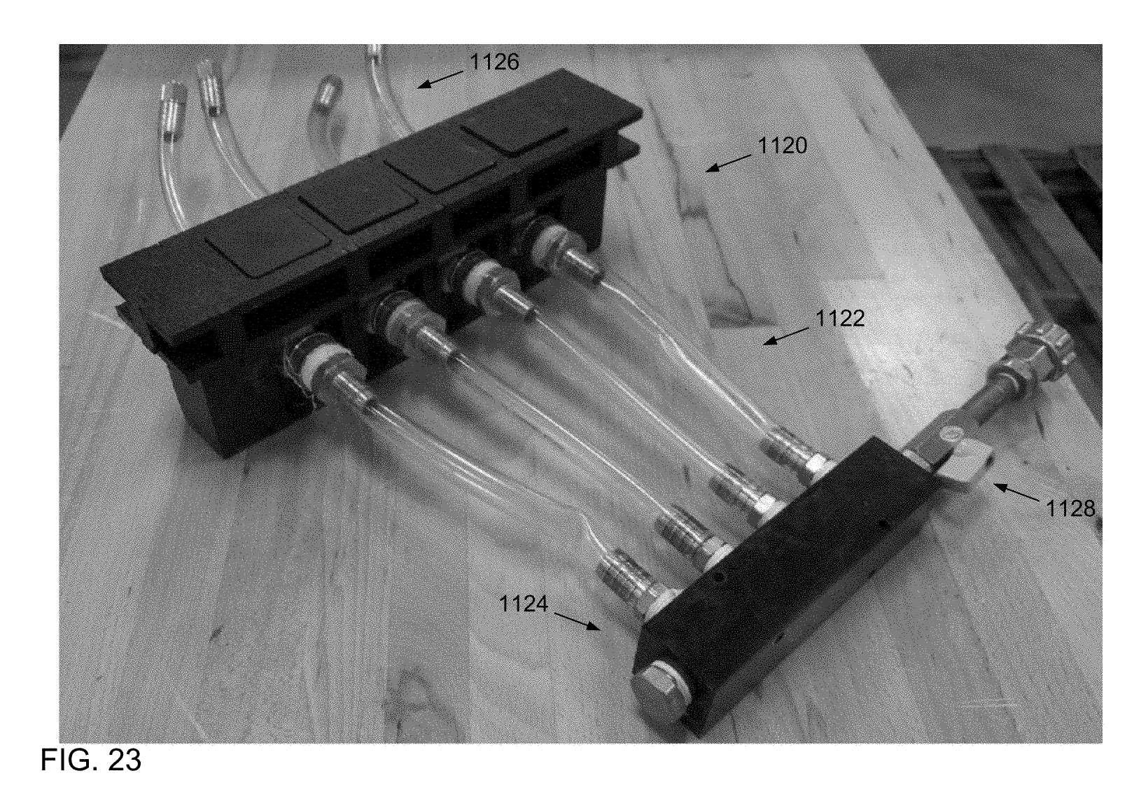

A water flow control assembly 1120 in accordance with another preferred embodiment actually was reduced to practice and is seen in FIG. 23. This control assembly 1120 represents a proof-of-concept.

As seen in FIG. 23, water input lines generally indicated at 1122 extend from an input manifold 1124 to the control assembly 1120. Water output lines extending from the control assembly 1120 on the other side are generally indicated at 1126. A water cut-off valve further is shown at 1128 for controlling the flow of incoming waster to the input manifold 1124. Water flows through one of the water output lines 1126 depending on which valve of the four valves of the control assembly 1120 is open, the other three being closed.

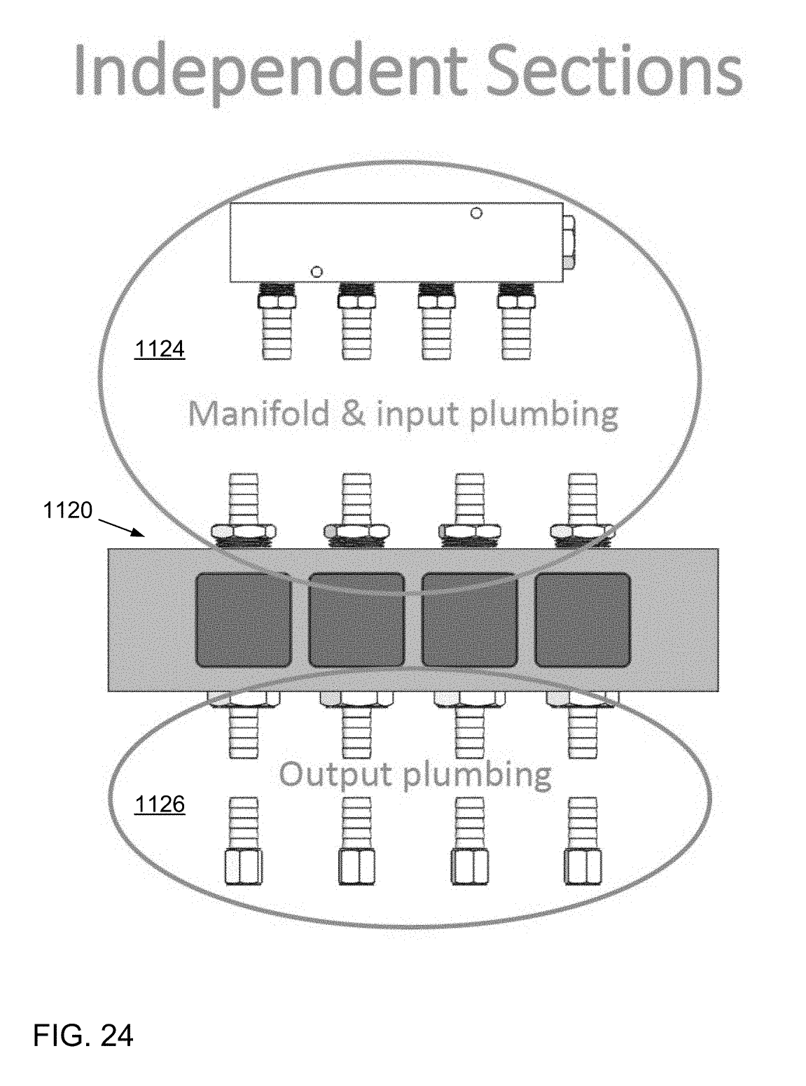

The relationship between the input manifold and associated plumbing 1124, output plumbing 1126, and control assembly 1120 is schematically represented in FIG. 24. The output plumbing collectively leads to the arrangements of sprayers, which each output line feeding one or more of the arrangements of sprayers.

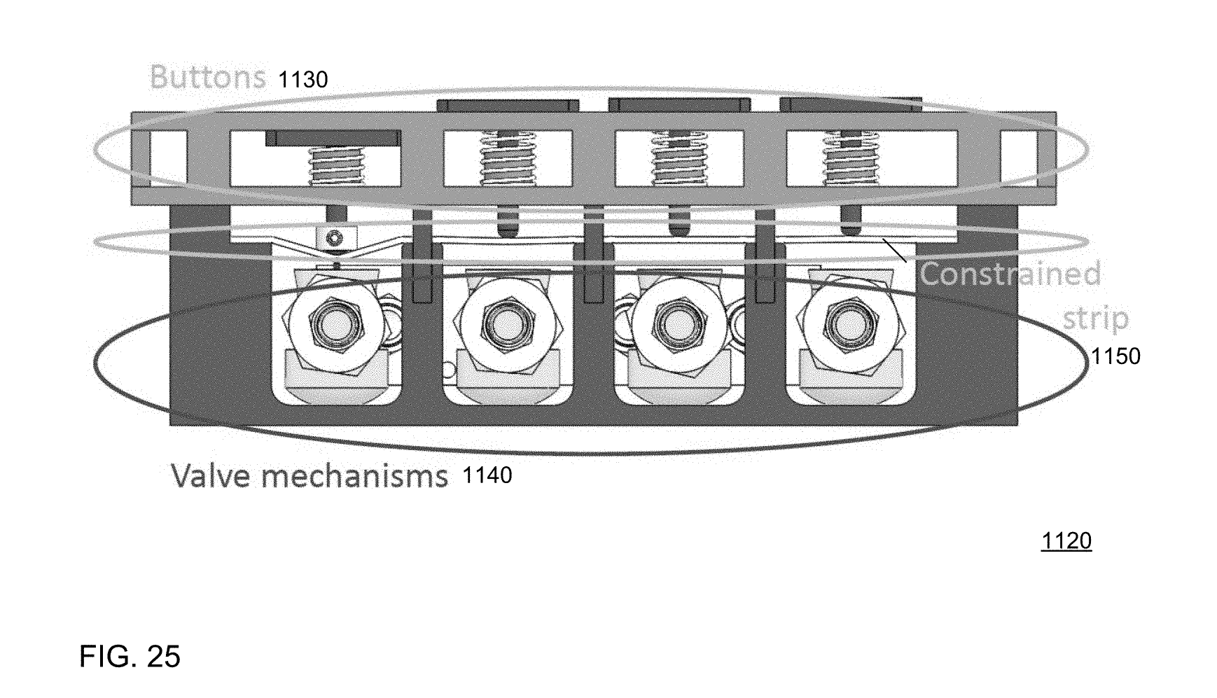

FIG. 25 is a schematic elevational view of the control assembly 1120 and serves to illustrate the three general types of components, including the buttons generally indicated by 1130; the constrained strip 1150; and the valve mechanisms generally indicated by 1140. The constrained strip 1150 is used to open one of the plurality of valve mechanisms 1140 one-at-a-time while simultaneously closing the valve mechanism preciously open. Moreover, the design of the valve mechanisms 1140 may vary so long as the constrained strip 1150 so activates a valve mechanism while closing the open valve mechanism and while keeping the other valve mechanisms closed. Each button in turn serves to cause the constrained strip to act on the valve mechanism corresponding to that button and, in so doing, causes the strip to “straighten” elsewhere along the length of the control assembly 1120.

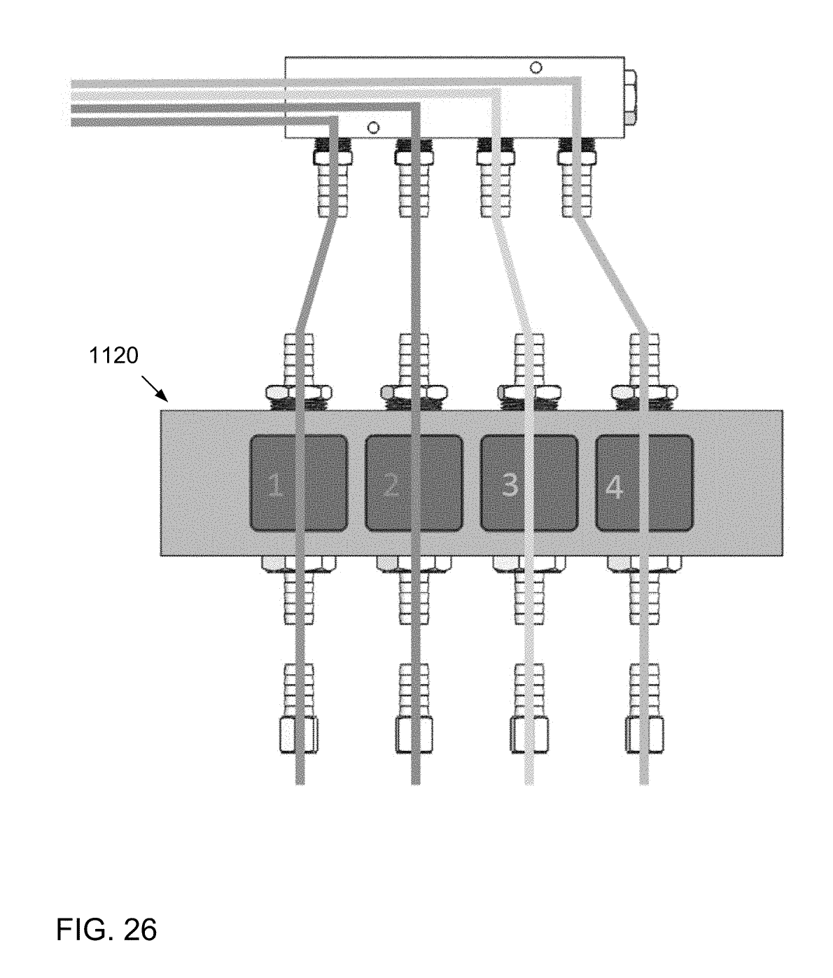

Accordingly, with four valves for example, the water flow control assembly is able to cause a single, exclusive flow out of four possible flows 1,2,3,4, as illustrated schematically in FIG. 26. The resulting flow then may continue to one or more of the arrangements of sprayers. Thus, for instance, flow 1 may correspond to a “FULL” button, with water flowing to all sprayers of the arrangements of a shower panel of a shower apparatus; flow 2 may correspond to a “BODY” button, with water flowing to the sprayers of only a subset of the arrangements of the shower apparatus; flow 3 may correspond to a “HEAD” button, with water flowing to the sprayers of only one or more arrangements located at the top portion of the shower panel of the shower apparatus; and flow 4 may correspond to a “RINSE” button, with water flowing to the sprayers only of the one or more lower arrangements of the shower panel of the shower apparatus.

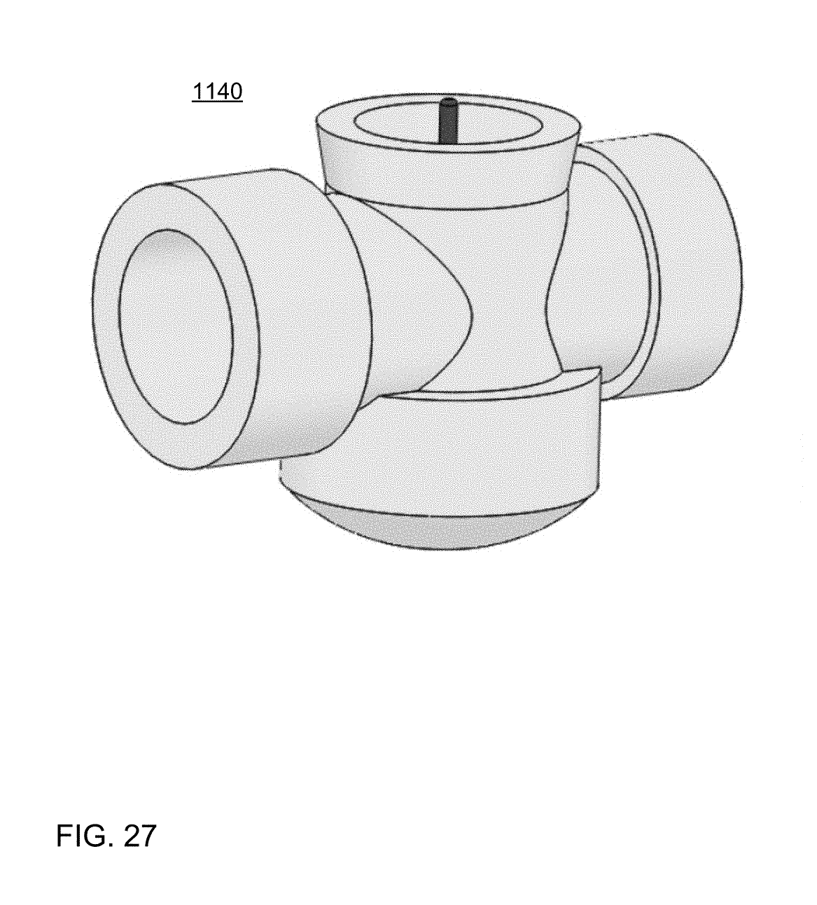

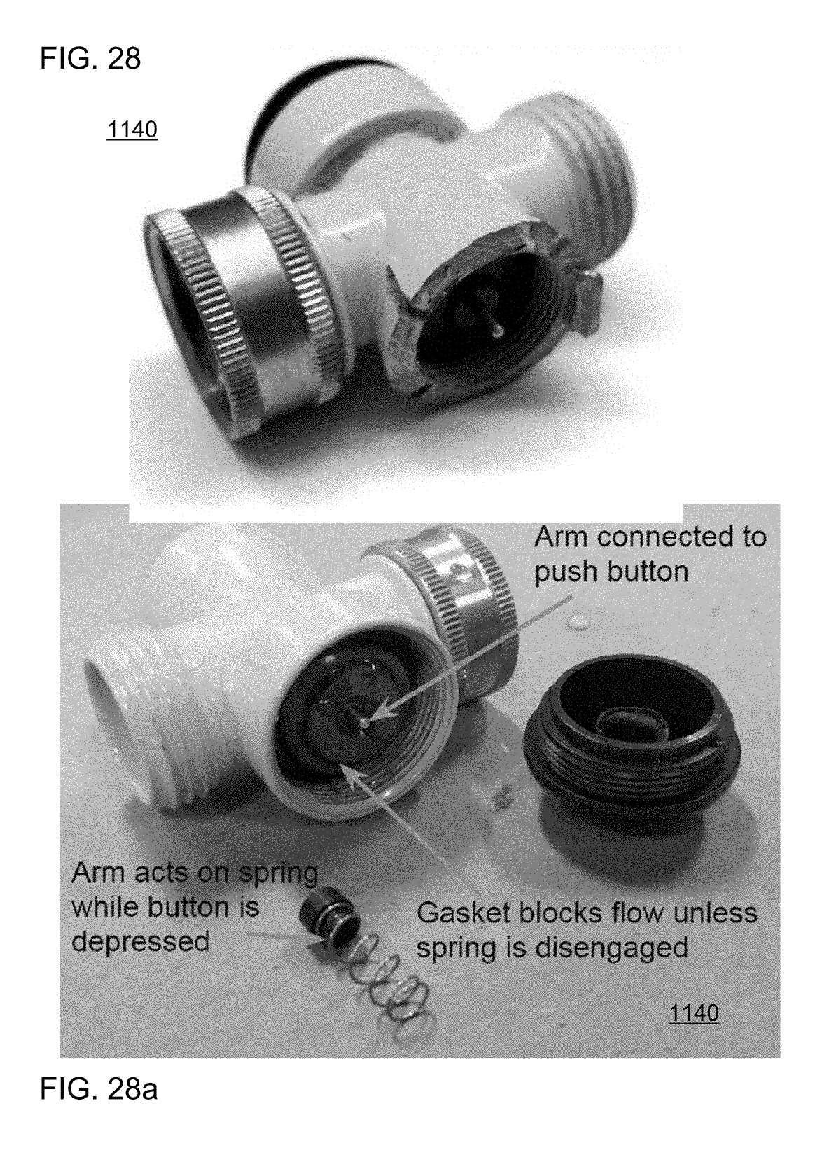

FIGS. 27, 28, and 28a illustrate in greater detail the valve mechanisms 1140 used in the proof-of-concept control assembly 1124. Each valve mechanism was acquired from an existing product, namely, a “QVS Push Button Shut-Off Valve”, which structure is believed to be disclosed in U.S. Pat. No. 6,352,212, incorporated herein by reference for such disclosure.

### Water Flow Control Assembly: Operation of the Second Illustrated Preferred Embodiment

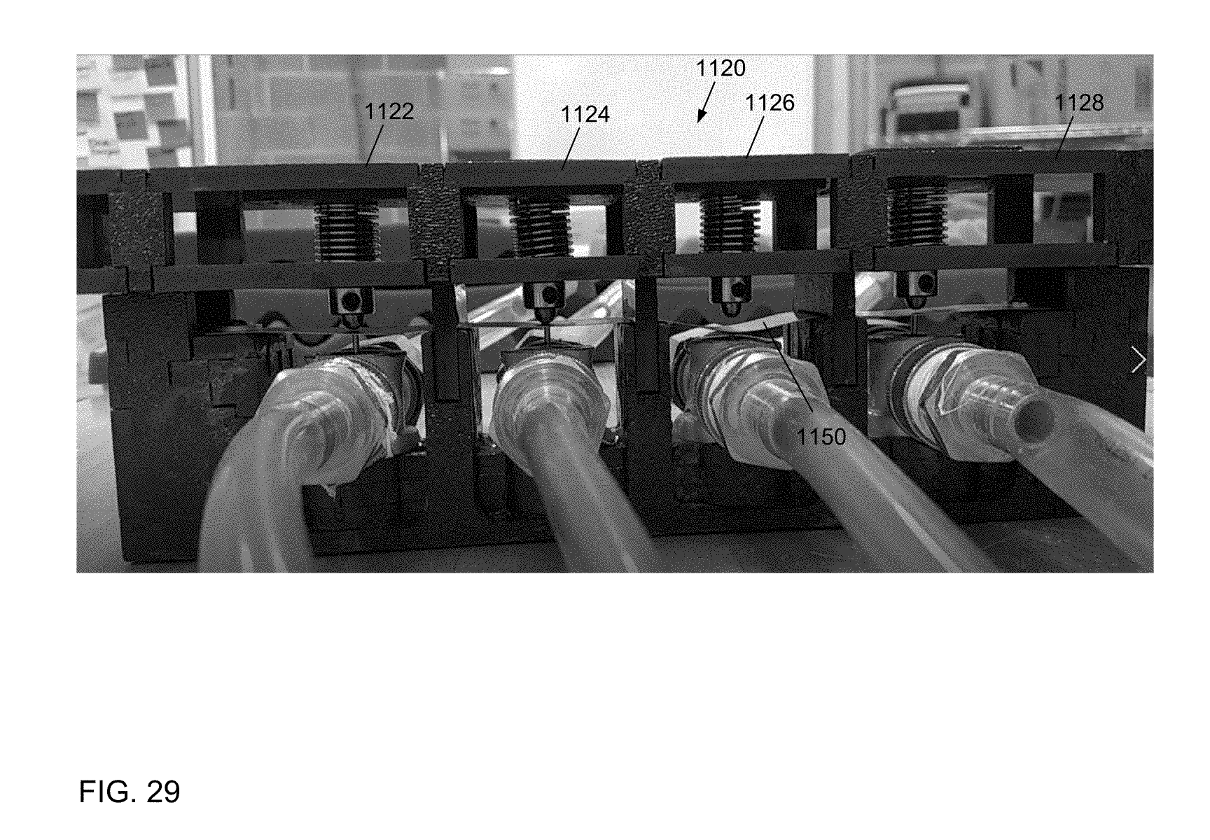

FIGS. 29-38 demonstrate the operation of the water flow control assembly 1120; and the videos of the computer program listing show both the dry and wet operations of the control assembly 1120.

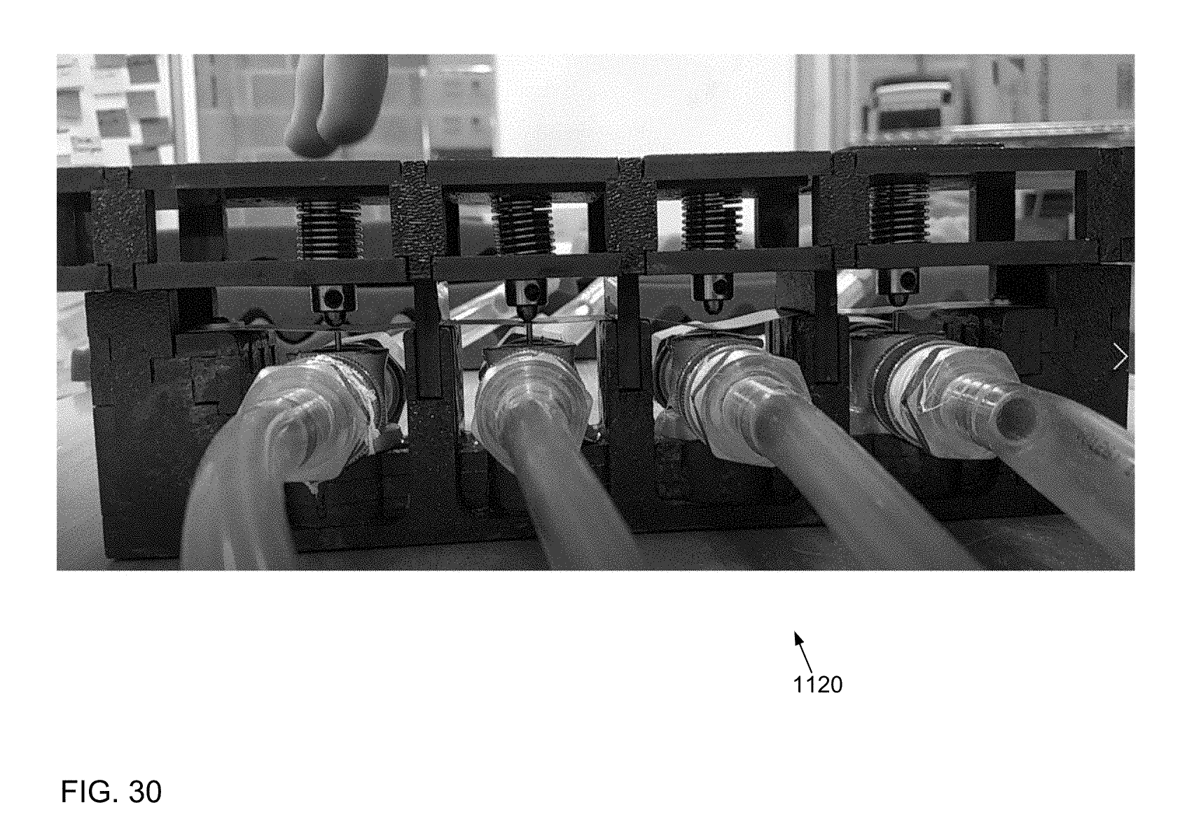

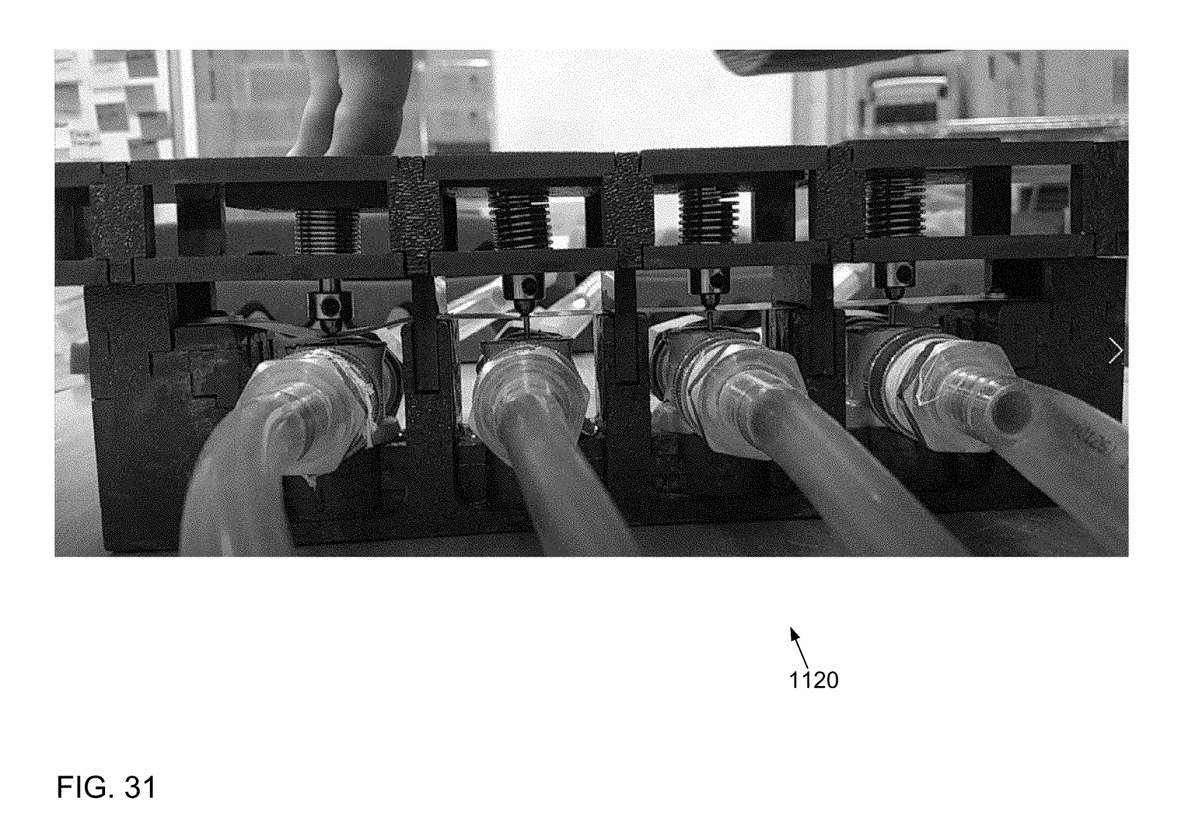

With reference to the sequence shown in FIGS. 29-38, the valve corresponding to push button 1126 is open. In FIG. 30, push button 1122 is about to be depressed, and in FIG. 31, push button 1122 is seen as having now been depressed. As a result, the constrained strip 1150 is deflected and engages the valve corresponding to push button 1122, thereby opening this valve. At the same time, the constrained strip 1150 straightens out and no longer engages the valve corresponding to push button 1126, thereby resulting in the closing of this previously opened valve.

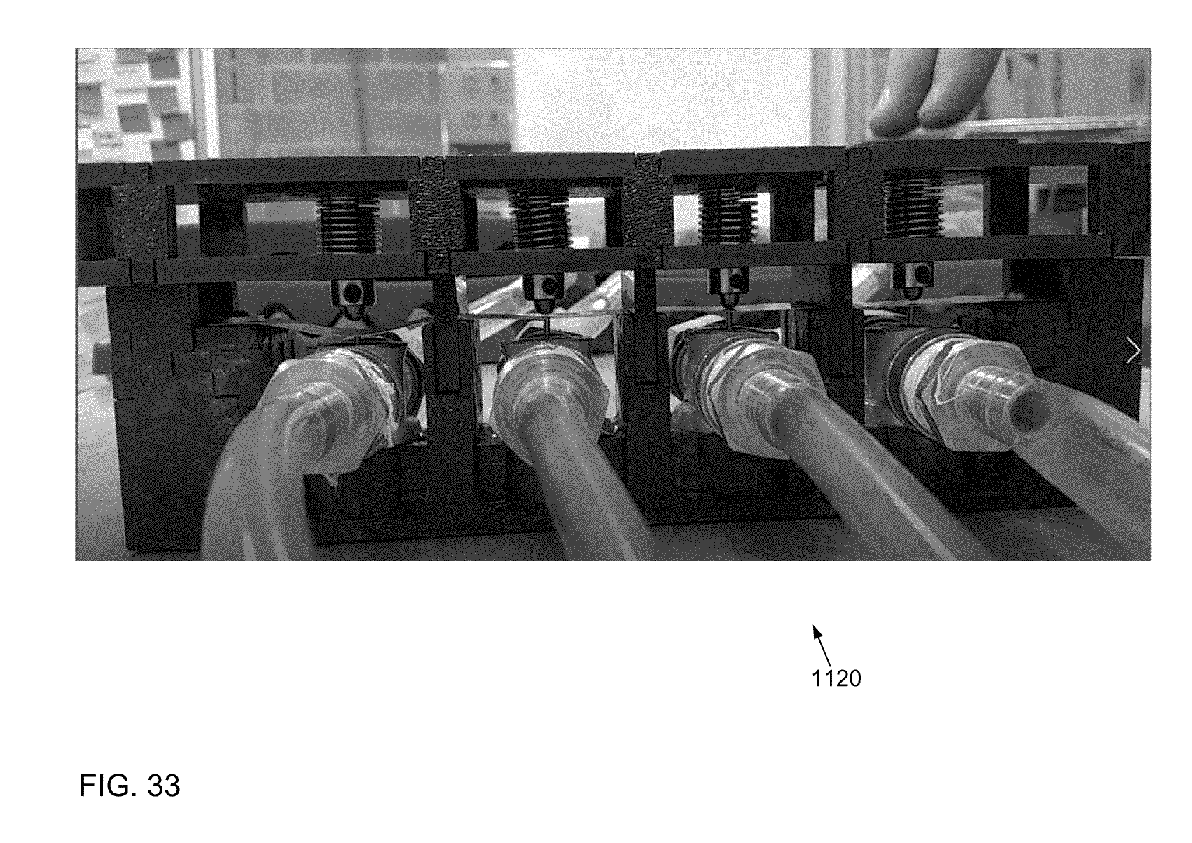

FIG. 33 shows the push button 1122 no longer being manually depressed and the push button 1122 having returned to its previous position as a result of a biasing spring of the control assembly 1120; however, it will be understood and appreciated that the deflection of the constrained strip 1150 remains, whereby the valve corresponding to push button 1122 remains open in FIG. 33.

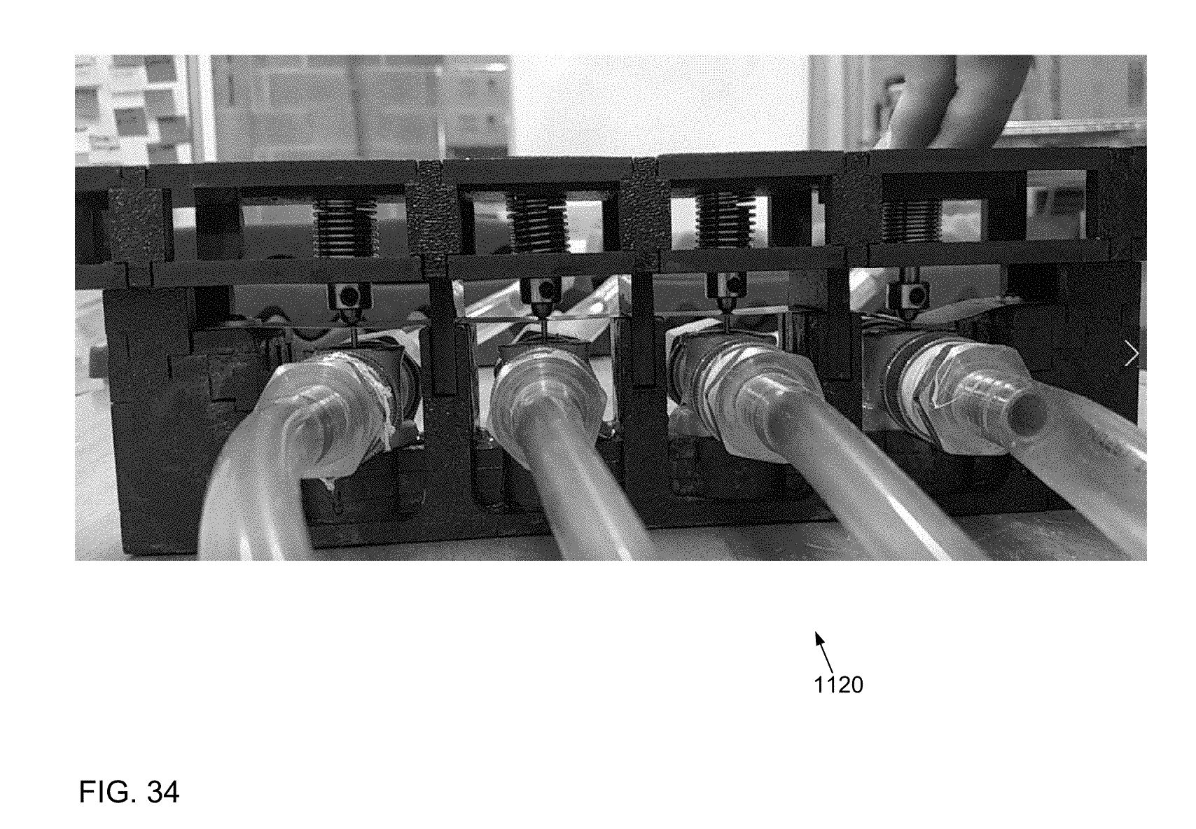

FIG. 34 shows push button 1122 is seen as having now been depressed. As a result, the constrained strip 1150 is deflected and engages the valve corresponding to push button 1128, thereby opening this valve. At the same time, the constrained strip 1150 straightens out and no longer engages the valve corresponding to push button 1122, thereby resulting in the closing of this previously opened valve.

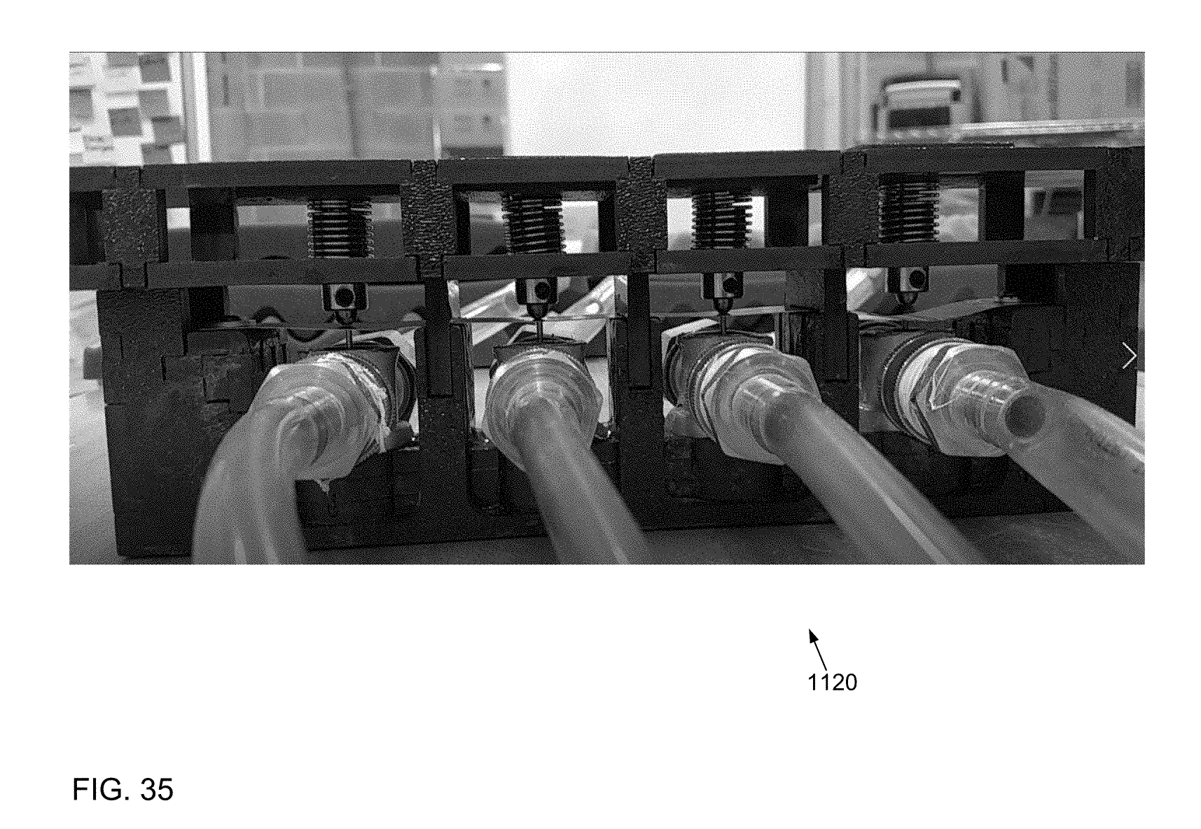

FIG. 35 shows the push button 1128 no longer being manually depressed and the push button 1128 having returned to its previous position as a result of a biasing spring of the control assembly 1120; however, it will be understood and appreciated that the deflection of the constrained strip 1150 remains, whereby the valve corresponding to push button 1128 remains open in FIG. 35.

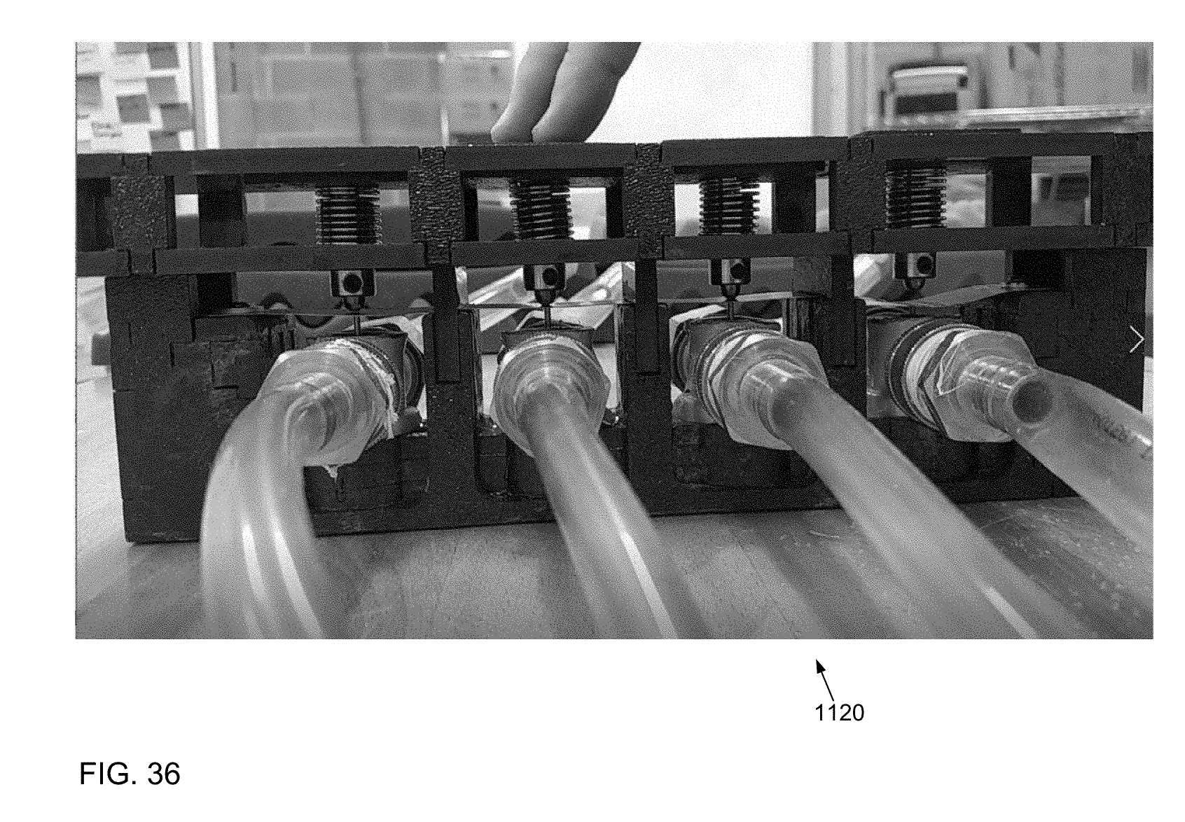

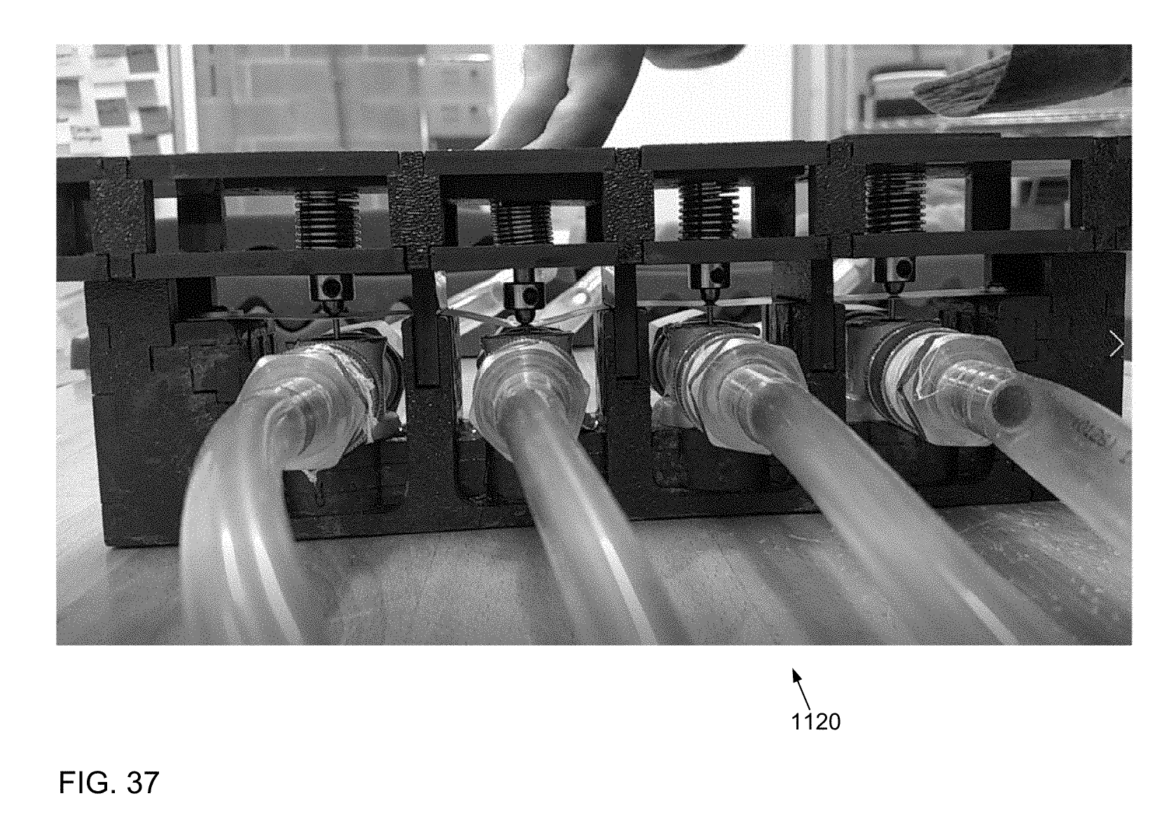

In FIG. 36, push button 1124 is about to be depressed, and in FIG. 37, push button 1124 is seen as having now been depressed. As a result, the constrained strip 1150 is deflected and engages the valve corresponding to push button 1124, thereby opening this valve. At the same time, the constrained strip 1150 straightens out and no longer engages the valve corresponding to push button 1128, thereby resulting in the closing of this previously opened valve.

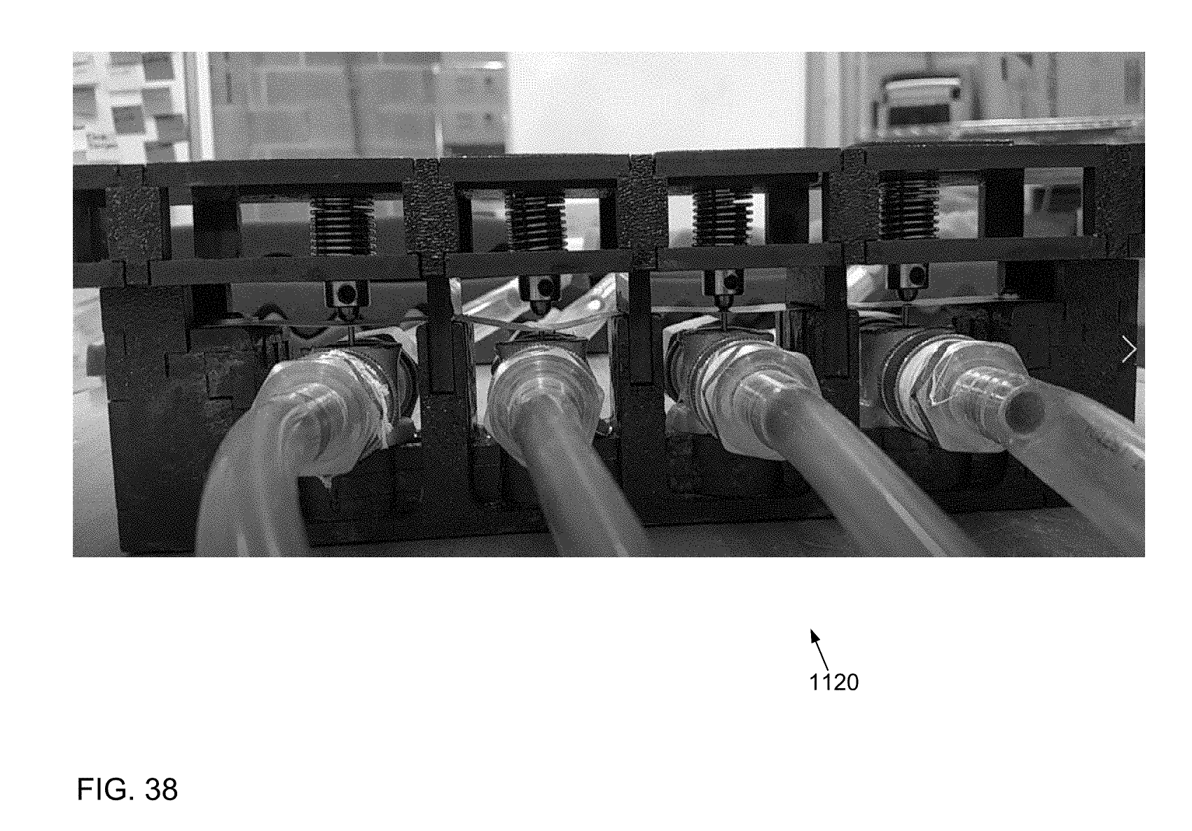

FIG. 38 shows the push button 1124 no longer being manually depressed and the push button 1124 having returned to its previous position as a result of a biasing spring of the control assembly 1120; however, it will be understood and appreciated that the deflection of the constrained strip 1150 remains, whereby the valve corresponding to push button 1124 remains open in FIG. 38.

### Commercial Design: Preferred Water Flow Control Assembly for a Shower Panel

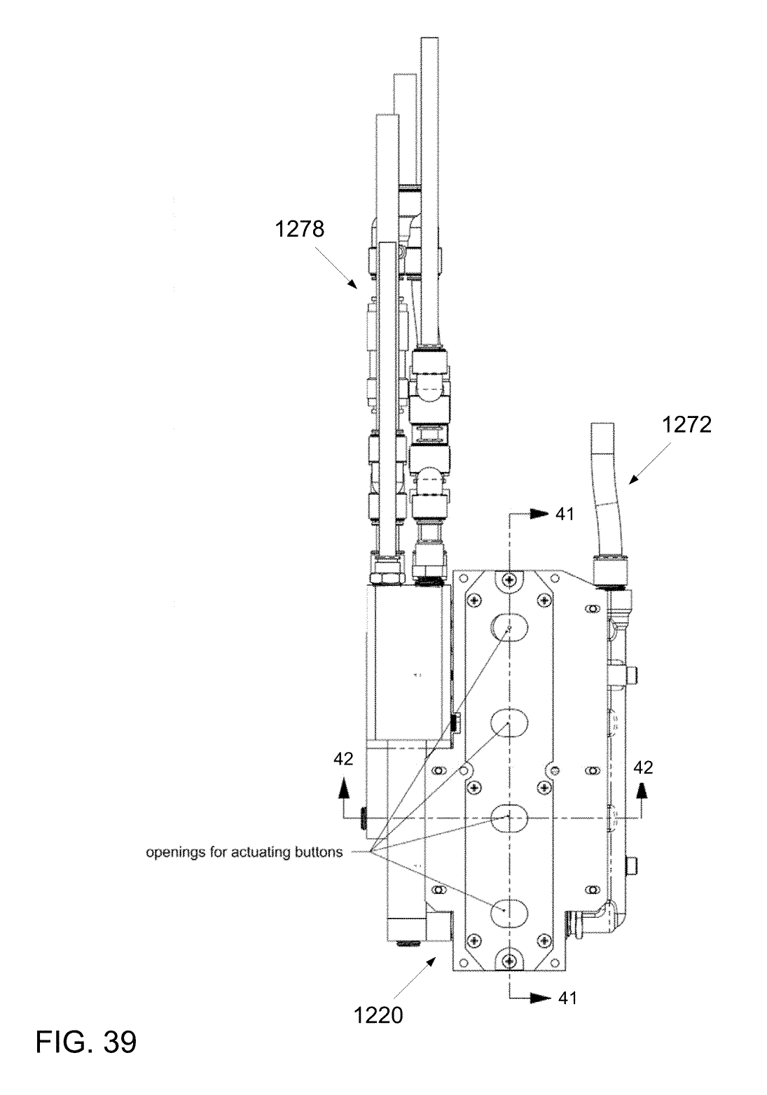

FIGS. 39-44 illustrate a schematic design for a preferred water flow control assembly 1220 in accordance with a preferred embodiment, which is intended for manufacture and use in a preferred, commercial shower panel of a shower apparatus of the invention. The control assembly 1220 of FIGS. 39-44 embodies the above disclosed inventive aspects and features, and further contains additional inventive aspects and features related to the commercialization step, including structural designs and arrangements believed to best effect commercialization of the invention.

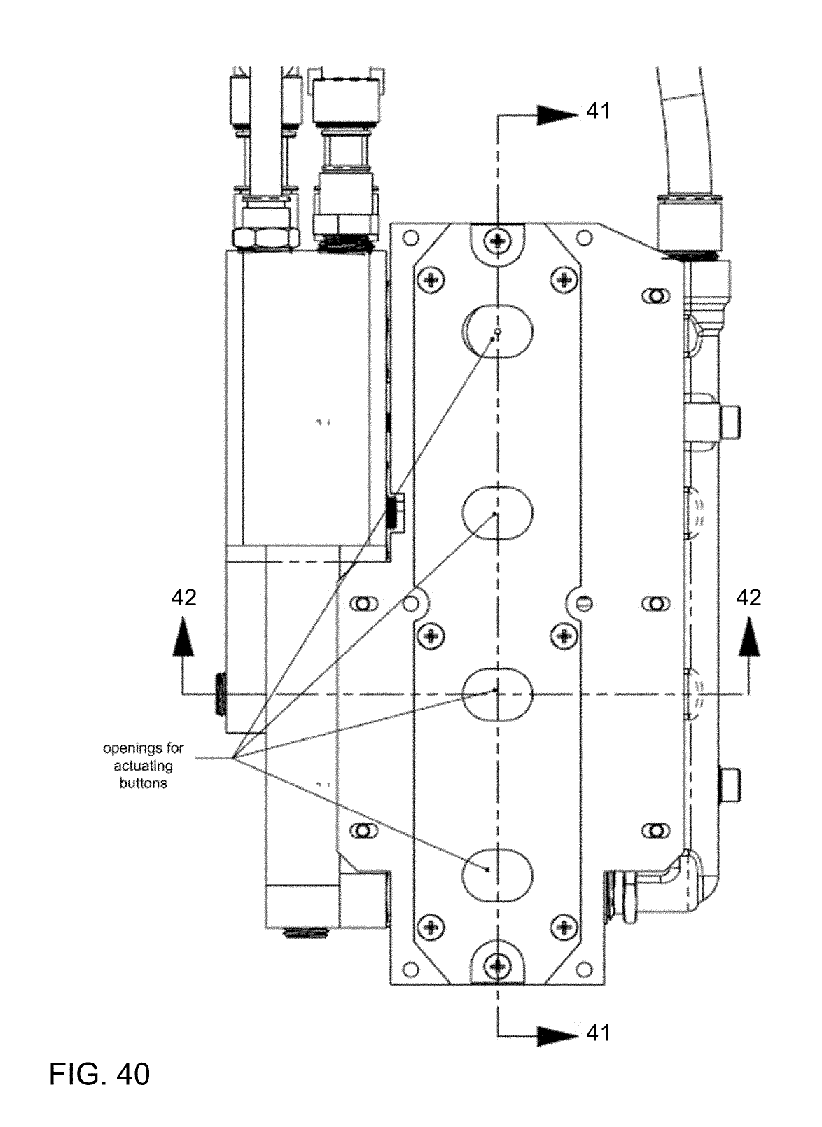

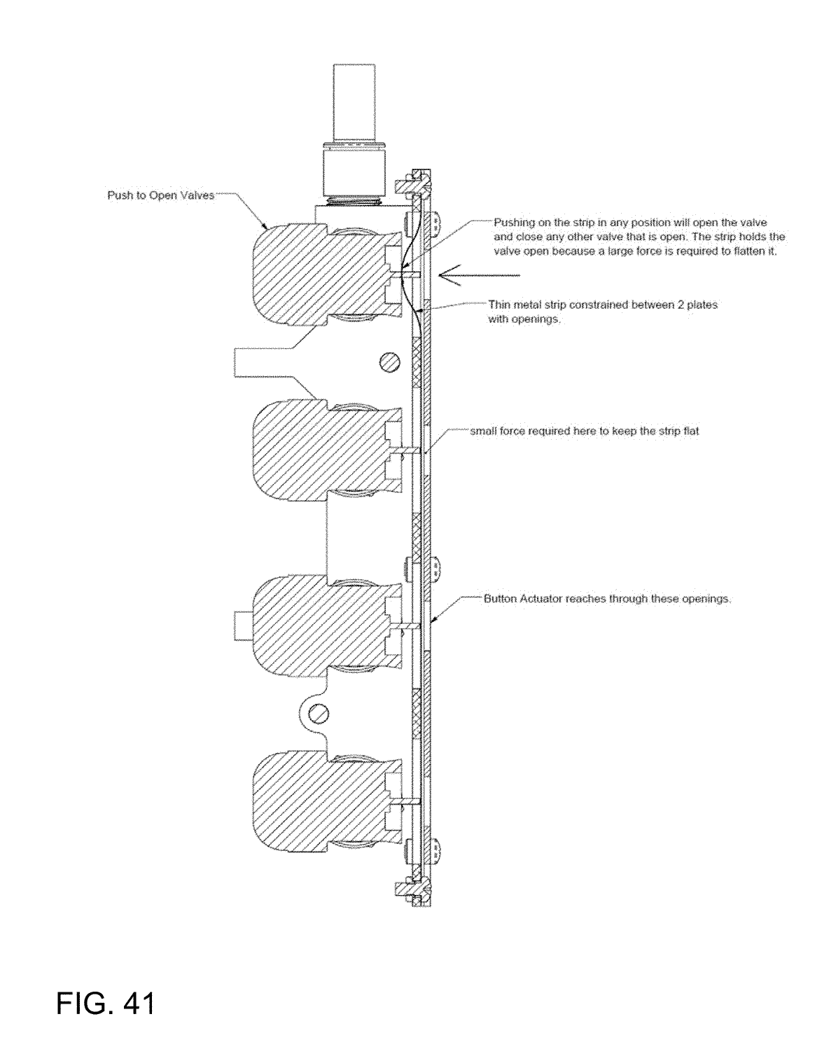

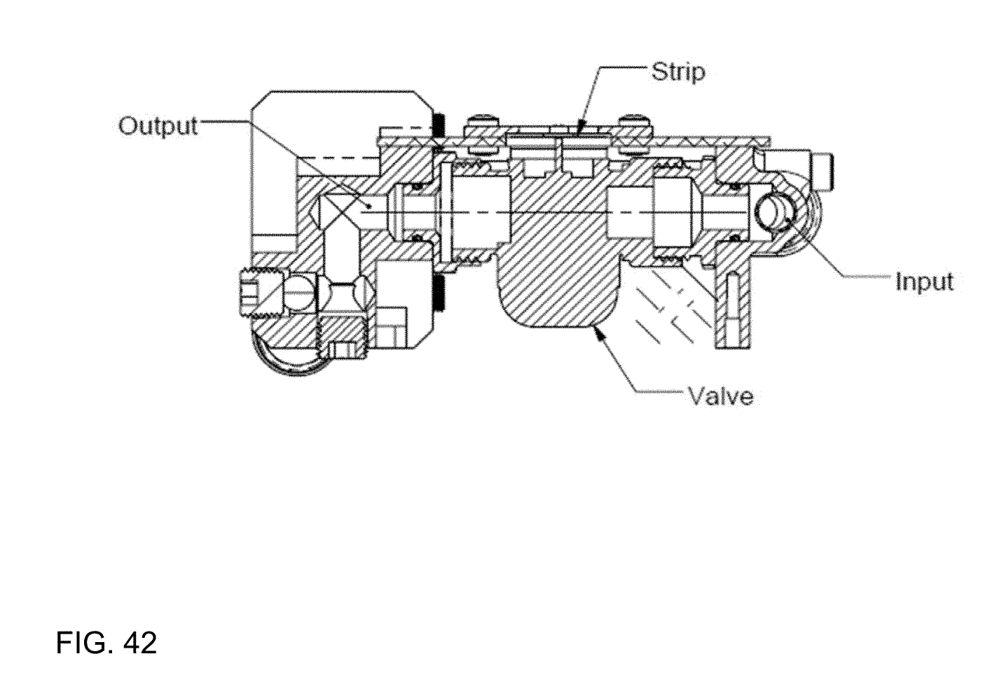

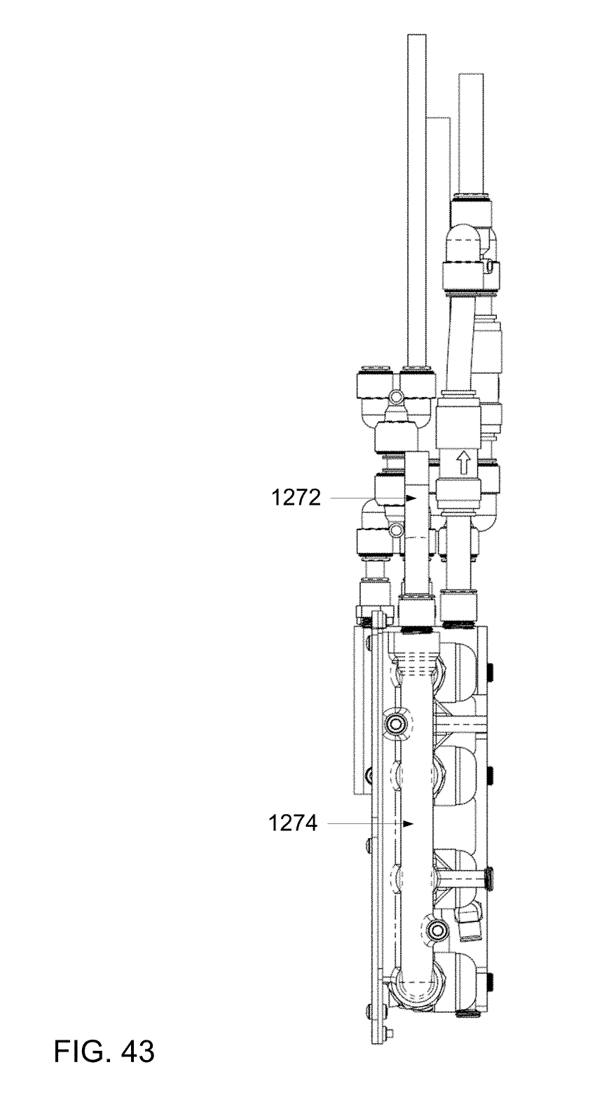

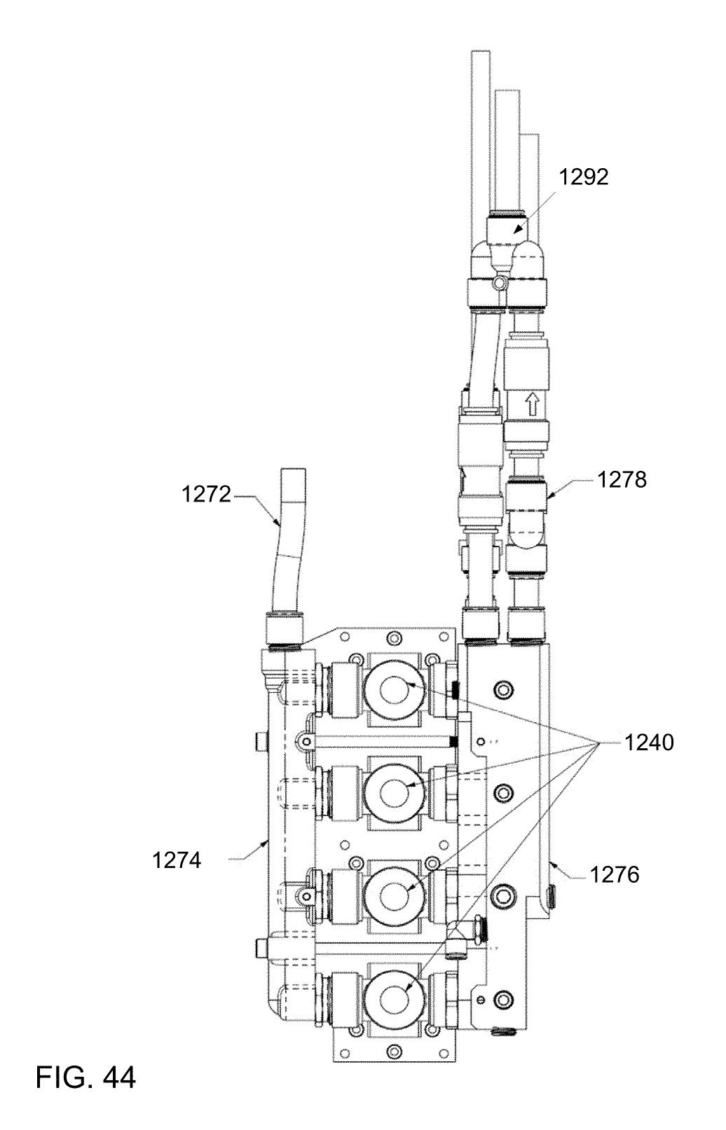

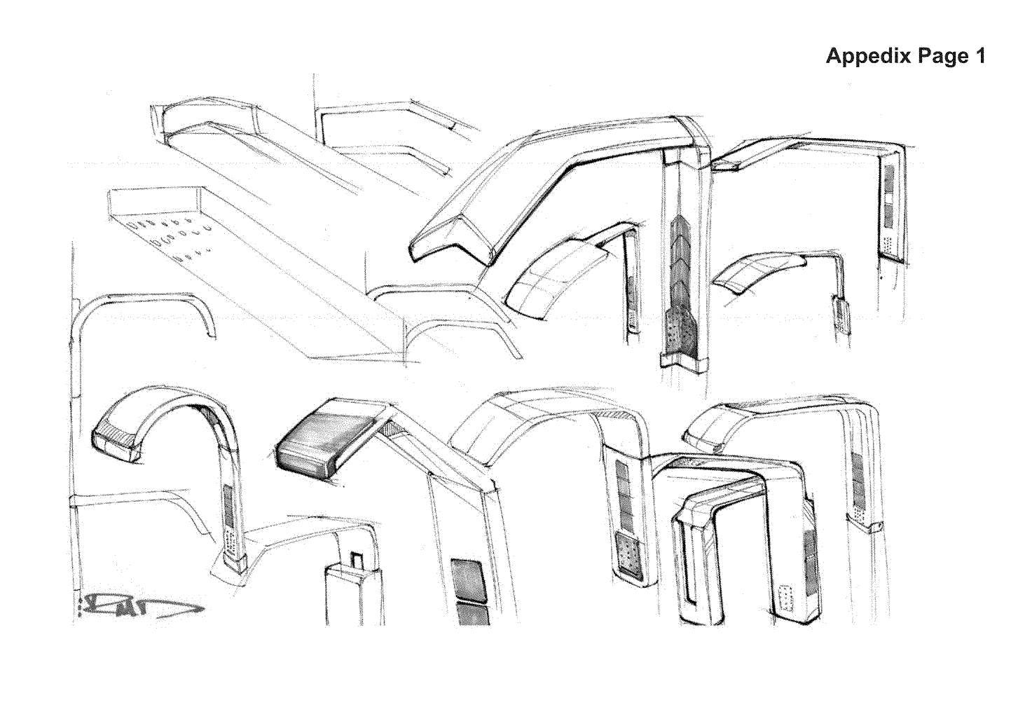

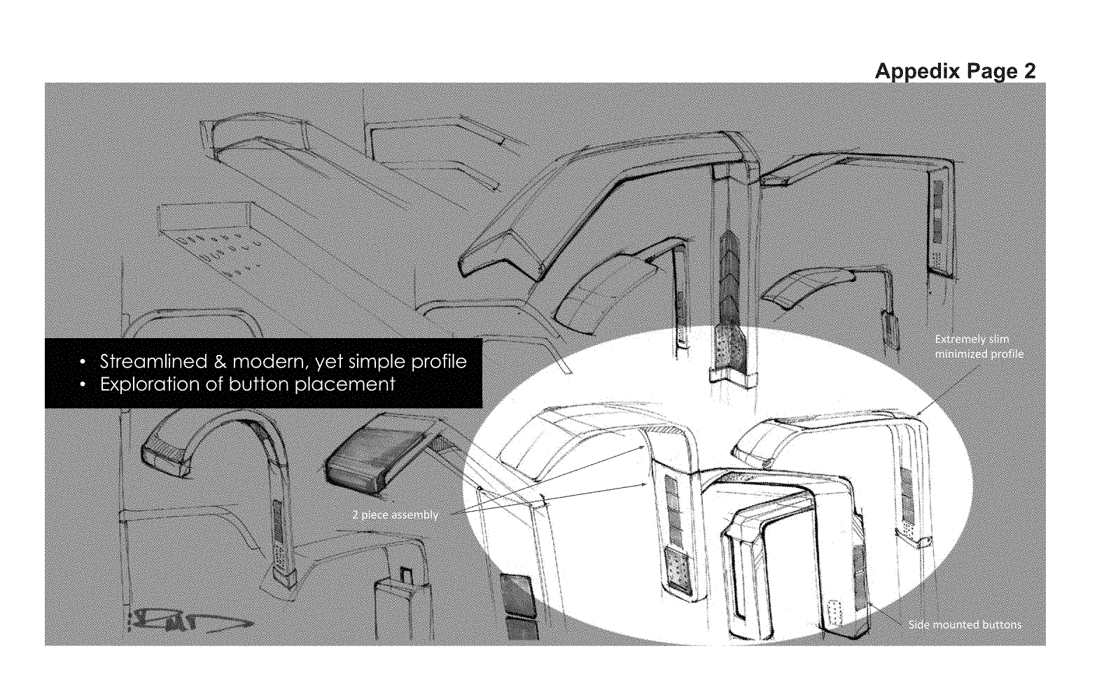

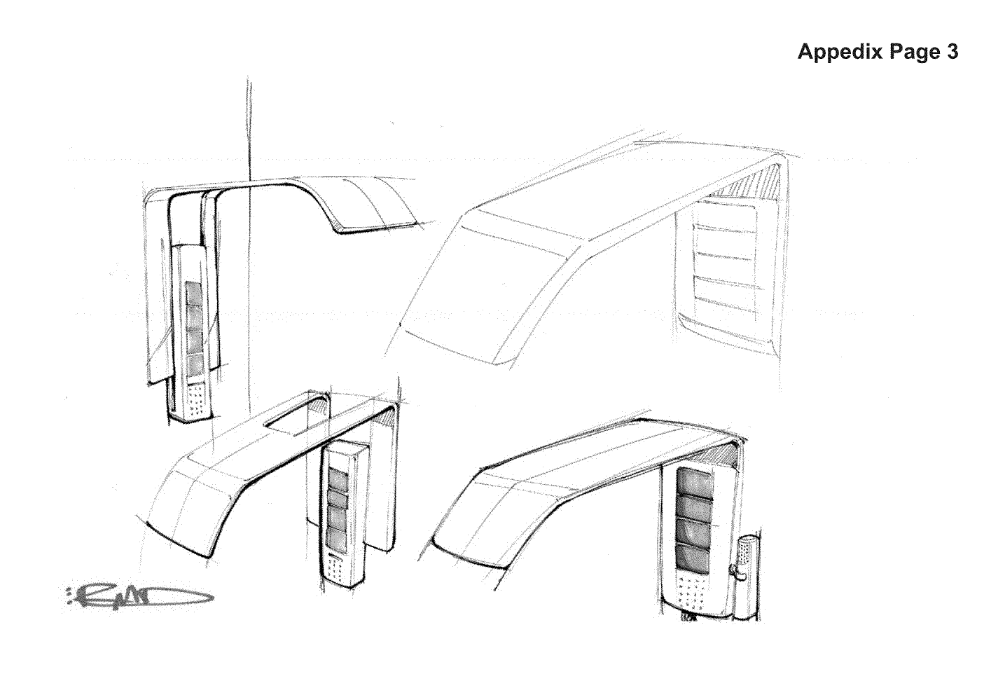

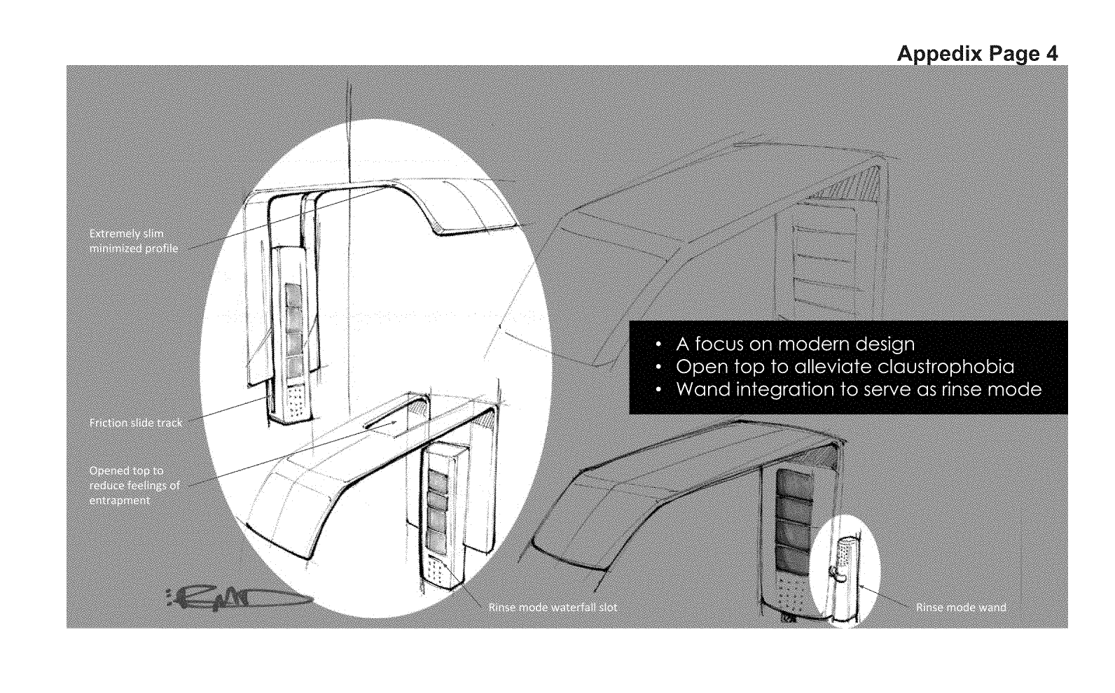

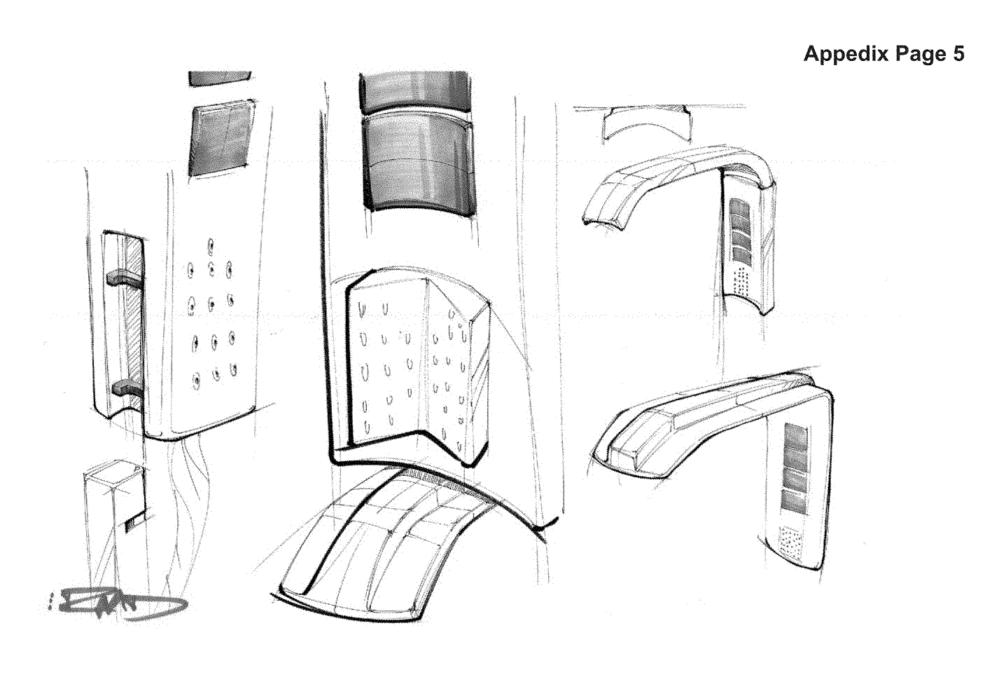

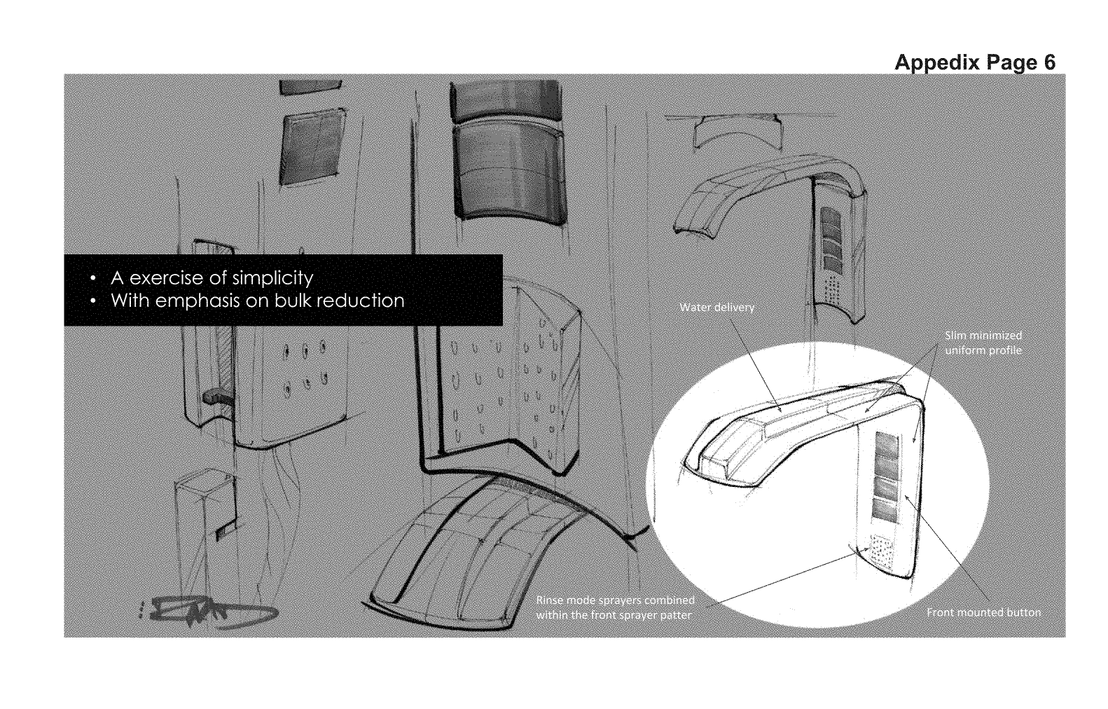

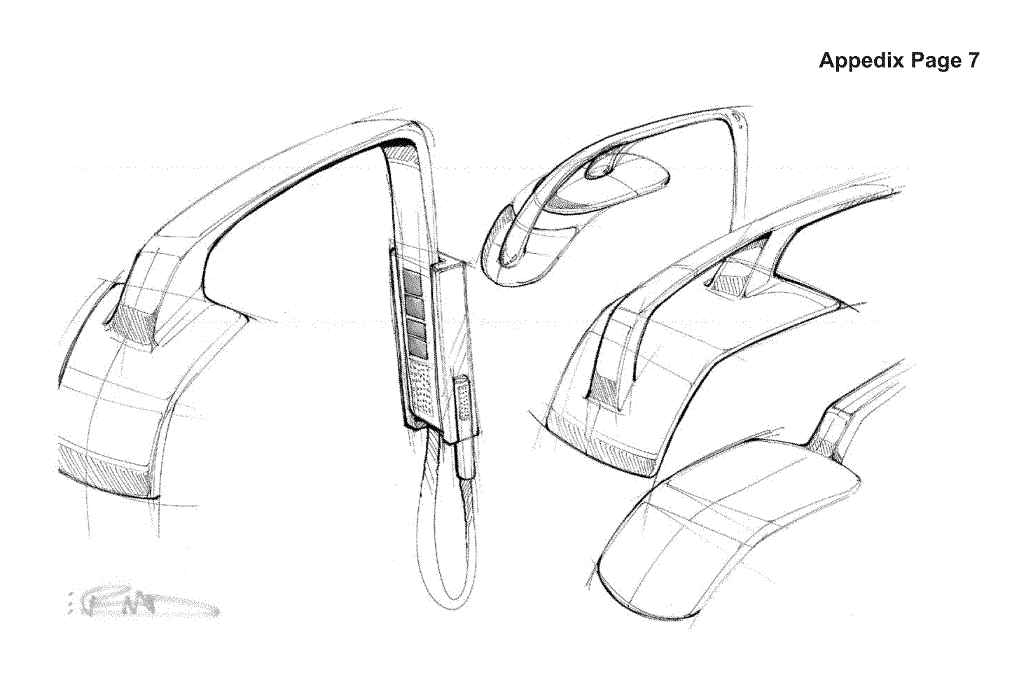

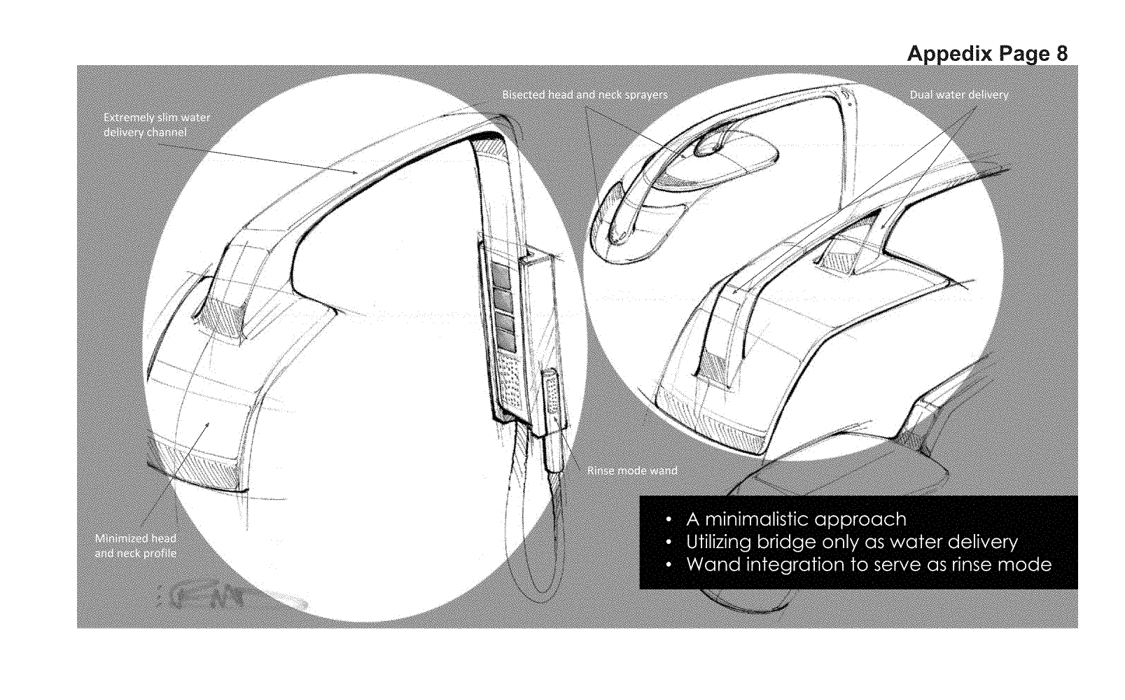

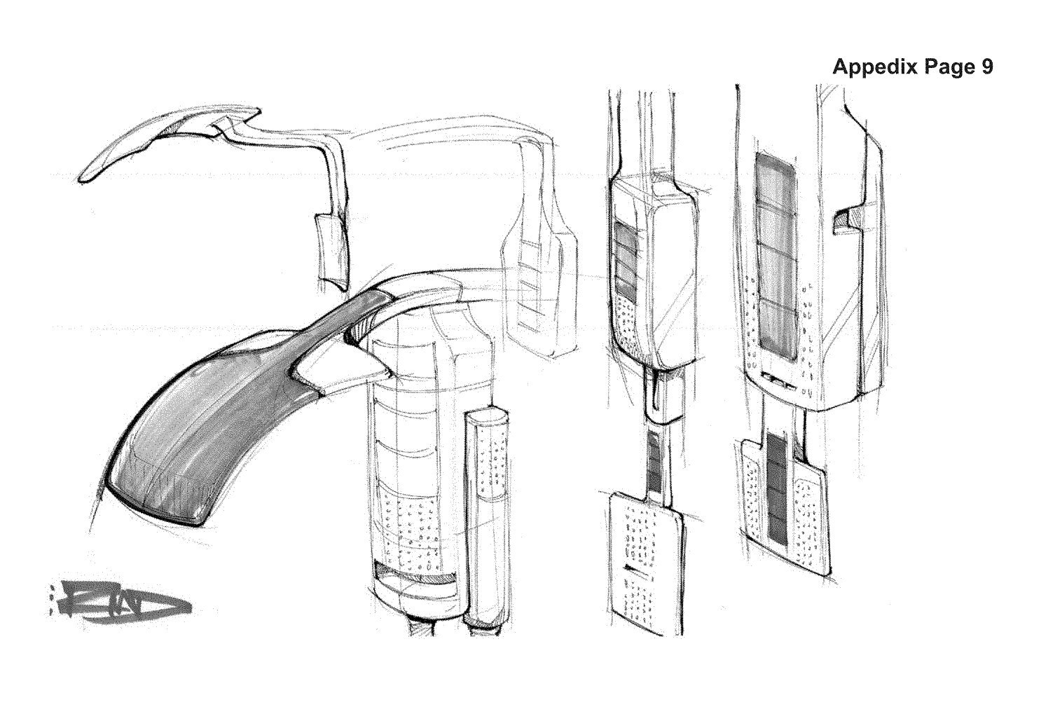

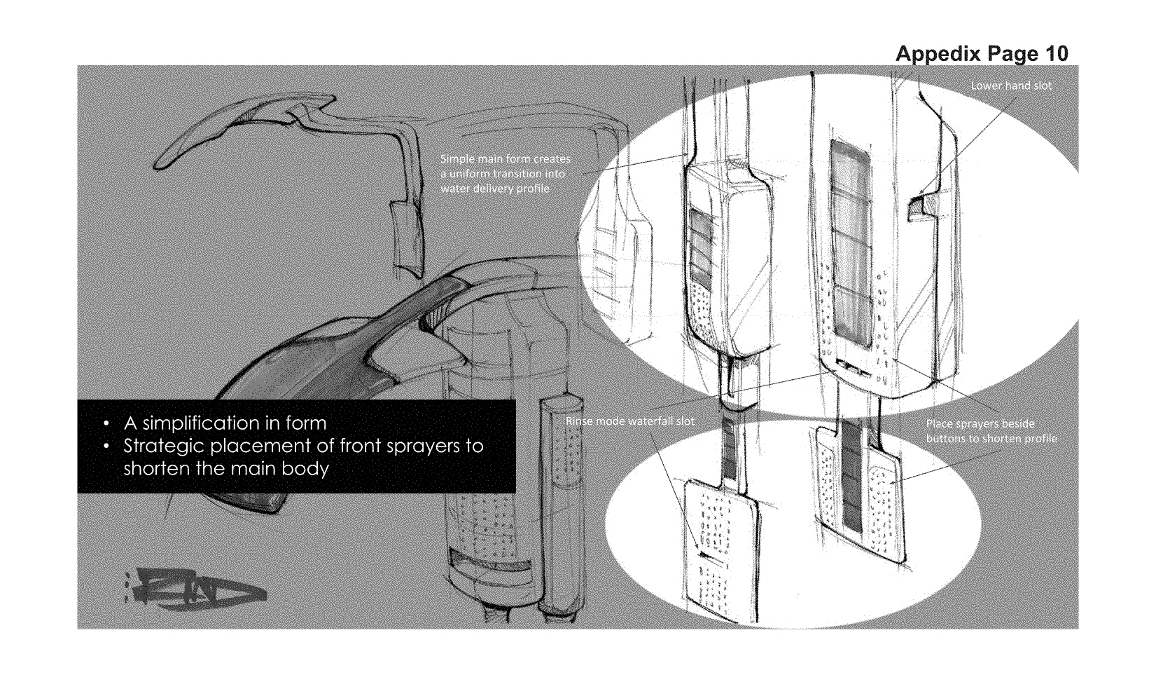

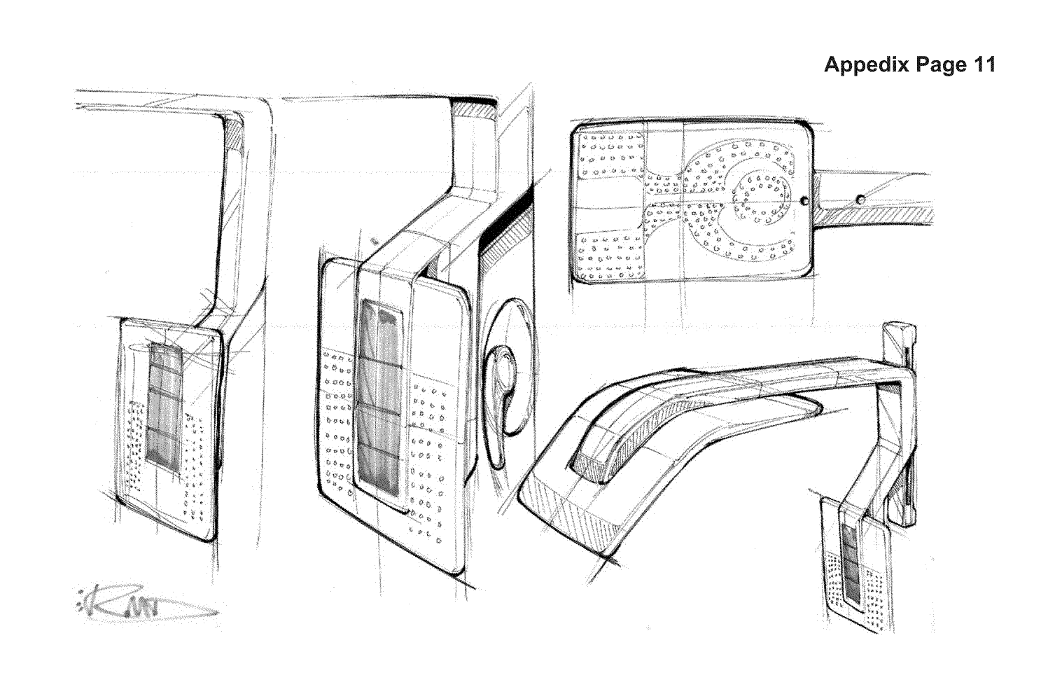

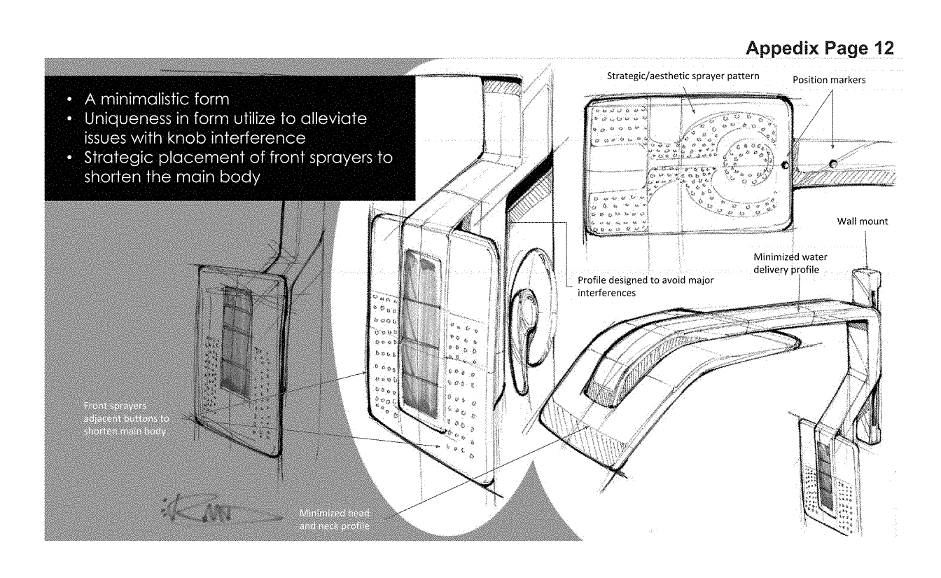

In this respect, FIG. 39 is a front elevational view of the design for the preferred water flow control assembly 1220, which view further includes associated components; FIG. 44 is a back elevational view thereof. FIG. 40 is an enlarged view of the design of the water flow control assembly 1220 of FIG. 39. FIG. 41 is a cross sectional view taken along the line 41-41 of FIG. 39; and FIG. 42 is a cross-sectional view taken along the line 42-42 of FIG. 39. FIG. 43 is a side elevational view of the preferred water flow control assembly 1220 and associated components of the design.

The preferred water flow control assembly 1220 and associated components of the design for a preferred, commercial shower panel of a shower apparatus are intended to generally fit within an enclosure of the shower panel of the shower apparatus, such as for example, shower panel 104 and shower panel 204. As seen in FIGS. 39-44, these components comprise the control assembly 1220 including four valves 1240; a water input line 1272; a water input manifold 1274; a water output manifold 1276; and a plurality of water output lines 1278. Furthermore, it will be seen that some flows of water through the water output lines 1278 combine, such as for example the inverted Y-juncture 1292. Alternatively, or additionally, water flows may be combined within defined conduits or fluid passageways of the output manifold 1276 itself prior to flowing to the water output lines 1278.

### Additional Contemplations

It will be appreciated that the buttons are currently “simple sprung platforms”, and are momentary and do not remain depressed once released. In alternative designs, it is contemplated that the buttons are attached to and held down by the constrained strip. Furthermore, it is contemplated that the spring force of the constrained strip could replace the compression springs seen in these illustrated control assemblies.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-19. (canceled)

20. A shower apparatus, comprising:
(a) a mounting bracket or mounting component; and
(b) a rigid component or shower panel;
(c) wherein the shower panel comprises one or more spray arrangements of sprayers, spray arrays, or spray patterns, and fluid passageways connecting water input to the one or more spray arrangements; and
(d) wherein the shower panel further comprises a water flow control assembly that includes buttons aligned in an array.

21-38. (canceled)

39. A shower apparatus comprising:
(a) a water flow control assembly comprising
(i) a plurality of buttons,
(ii) a constrained strip, and
(iii) a plurality of valves or valve mechanisms,
(iv) wherein each button when selected is intended to cause a corresponding one of the valve mechanisms to permit water to flow to a different grouping of one or more spray arrangements of the shower apparatus, whereby the water flow control assembly is able to cause a single, exclusive flow out of a plurality of possible flows; and
(b) a faucet mechanism configured to enable a user to adjust an amount of water flowing to the water flow control assembly as well as the temperature of the water by varying between different hot and cold water flows that combine into the water flow to the water flow control assembly.

40. The shower apparatus of claim 39, wherein the constrained strip comprises a number of hinged elements.

41. The shower apparatus of claim 39, wherein the constrained strip comprises a single sheet of material.

42. The shower apparatus of claim 39, wherein the constrained strip comprises a single sheet of spring steel.

43. The shower apparatus of claim 39, wherein the constrained strip comprises plastic.

44. The shower apparatus of claim 39, wherein the constrained strip is only long enough to have one deflection over its constrained length.

45. The shower apparatus of claim 39, wherein the depressing of one of the buttons causes a defection of the constrained strip at that location, straightening the strip at all other locations, the deflection in the strip at that location engaging and acting on a valve mechanism to open the valve, thereby permitting fluid flow therethrough.

46. The shower apparatus of claim 39, further comprising a shaft collar for setting a maximum height of the button upon return due to a spring force after being depressed.

47. The shower apparatus of claim 39, wherein the faucet mechanism comprising a water shut-off valve.

48. The shower apparatus of claim 39, further comprising a water input line; a water input manifold; a water output manifold; and a plurality of water output lines.

49. The shower apparatus of claim 39, further comprising an inverted Y-juncture for combining flows in two of the water output lines.

50. A water flow control assembly for a shower apparatus, comprising
(i) a plurality of buttons,
(ii) a constrained strip, and
(iii) a plurality of valves or valve mechanisms,
(iv) wherein each button when selected is intended to cause a corresponding one of the valve mechanisms to permit water to flow therethrough and to cause a previously open valve mechanism to close, whereby water flow through the control assembly is limited to flow through a single, exclusive valve mechanism.

51. The water flow control assembly of claim 50, wherein the constrained strip comprises a number of hinged elements.

52. The water flow control assembly of claim 50, wherein the constrained strip comprises a single sheet of material.

53. The water flow control assembly of claim 50, wherein the constrained strip comprises a single sheet of spring steel.

54. The water flow control assembly of claim 50, wherein the constrained strip comprises plastic.

55. The water flow control assembly of claim 50, wherein the constrained strip is only long enough to have one deflection over its constrained length.

56. The water flow control assembly of claim 50, wherein the depressing of one of the buttons causes a defection of the constrained strip at that location, straightening the strip at all other locations, the deflection in the strip at that location engaging and acting on a valve mechanism to open the valve, thereby permitting fluid flow therethrough.

57. The water flow control assembly of claim 50, further comprising a shaft collar for setting a maximum height of the button upon return due to a spring force after being depressed.

58-61. (canceled)
